(19) United States
(12) Patent Application Publication
(10) Pub. No.: US 2012/0000313 A1
(43) Pub. Date: Jan. 5, 2012

(54) ACCESSORIES FOR A BICYCLE AND THE LIKE, AND METHOD FOR ACCESSING ARTICLES FROM A MOVING BICYCLE AND THE LIKE

(76) Inventor: Yoav ZACKS, Mevasseret Zion (IL)

(21) Appl. No.: 13/105,150

(22) Filed: May 11, 2011

Related U.S. Application Data
(60) Provisional application No. 61/333,939, filed on May 12, 2010.
(60) Provisional application No. 61/443,878, filed on Feb. 17, 2011.

(51) Int. Cl. B62K 21/12

(52) U.S. Cl. 74/551.8

(57) ABSTRACT

There is provided an apparatus configured for being fixedly secured to a handlebar of a bicycle and for use with one or more retrievable storage units stowed within the handlebar.

This application claims the benefit of prior U.S. provisional patent application No. 61/333,939, filed on May 12, 2010, and of prior U.S. provisional patent application No. 61/443,878, filed on Feb. 17, 2011, and the contents of both said U.S. provisional patent applications are hereby incorporated herein by reference in their entirety.

### FIELD OF THE INVENTION

This invention relates to storage and to retrieval of items inside a bicycle or the like.

### BACKGROUND OF THE INVENTION

Storage systems for items associated with bicycles and cyclists (also referred to interchangeably herein as bicycle riders or riders) are generally found in three categories: (a) storage units carried on the person of the cyclist; (b) storage units externally mounted to the bicycle; (c) storage units that utilize part of the inside of the bicycle handle bar. Retrieval of such items, particularly on the go, when the cyclist is riding the bicycle at speed and requires to control the bicycle and to maintain and/or to change speed, presents unique challenges. These challenges are even more acute with road bikes (also referred to interchangeably herein as road bicycles, racing bikes or racing bicycles), with the requirements for low bicycle weight, high cycling speeds and frequent intake of energy and nutritional products by the cyclist. Such products are often in the form of gel packages and the like, for example as disclosed in US 2006/0280777, the contents of which are incorporated fully herein by reference, and there are currently many such products commercially available.

The first category often takes the form of pockets integral with the cyclist's clothing and has the advantage of requiring no modifications or accessories to the bicycle itself While retrieval of the stored items, particularly on the go, can often be difficult and may require some cyclists to slow down for this purpose, this type of solution incurs no weight penalty on the bicycle per se and is often favored by road bike cyclists. On the other hand, many cyclists consider storing items in such pockets risky, as the items can fall out during cycling, and/or find it difficult to maneuver the hand to retrieve items from such pockets, and/or have to choose the right moment for such retrieval without other cyclists nearby to avoid possibility of collisions.

There are many known storage systems in categories (b) and (c). However, both categories result in a weight penalty to the bicycle, category (b) usually more so than category (c). Furthermore, known systems in category (c) are unsuitable for retrieval of the stored items while on the go, particularly using only one hand and/or while maintaining integrity of the bicycle's control systems.

By way of general background, the following patents disclose storage arrangements under category (b), and the contents of these patents are incorporated fully herein by reference: U.S. Pat. No. 5,894,955; U.S. Pat. No. 4,911,339; U.S. Pat. No. 6,045,020; U.S. Pat. No. 5,862,965; JP 2009051482. Further by way of general background, the following patents disclose storage arrangements under category (c), and the contents of these patents are incorporated fully herein by reference: U.S. Pat. No. 6,564,982; U.S. Pat. No. 5,950,498; CN 201120940; FR 2,707,243.

### SUMMARY OF THE INVENTION

According to a first aspect of the invention, there is provided an apparatus (also referred to interchangeably herein as an accessory) for a bicycle handlebar configured for being fixedly secured to a handlebar of a bicycle.

According to the first aspect of the invention, there is also provided an apparatus for a bicycle handlebar having an internal handlebar cavity in open communication with an open end of the handlebar, said open end having an edge and an external surface, the apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for releasably affixing thereto and for enabling retrieval of one or more items previously accommodated in the handlebar cavity via said ring member with one hand at least while the bicycle is in motion, and wherein said ring member is configured for remaining fixedly secured to the external surface at least during said retrieval. According to this aspect of the invention there is also provided a bicycle handlebar comprising such an apparatus, and also a bicycle comprising such a bicycle handlebar.

According to the first aspect of the invention there is also provided an apparatus for a bicycle handlebar having an internal handlebar cavity in open communication with an open end of the handlebar, said open end having an edge and an external surface, the apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for facilitating at least retrieval of one or more items previously accommodated in the handlebar cavity via said ring member with one hand at least while the bicycle is in motion, and wherein said ring member is configured for remaining fixedly secured to the external surface at least during said retrieval.

Said external surface of the open end of the handlebar extends from the edge, and thus comprises the cylindrical outer surface of the handlebar in the vicinity of the edge of the open end of the handlebar.

In at least some embodiments, the apparatus is further configured for enabling said open end to be selectively and alternately open and closed, at least when said ring member is fixedly secured to the external surface. The ring member may optionally comprise an end cap member configured for being selectively engaged and disengaged with respect to said ring member, wherein in use and said end cap member is engaged to the ring member the open end is closed and access denied to the handlebar cavity, and wherein in use and said end cap member is disengaged to the ring member the open end is open and access permitted to the handlebar cavity. For example, said end cap member may be hingedly connected to said ring member, or may be connected thereto in any suitable manner; alternatively, the cap may be fully removed when open.

In at least some embodiments including the above embodiments, the end cap is optionally sealingly engaged with respect to said ring member in the engaged position.

In at least one or more of the above embodiments, said ring member comprises a tubular casing having a first open casing end and a second open casing end, and a longitudinal passageway extending between said first open casing end and said second open casing end. In some such embodiments, said tubular casing comprises a longitudinal slit extending between said first open end and said second open end to define opposed longitudinal casing edges, wherein said longitudinal casing edges may be reversibly separated to facilitate engaging said ring member to the handlebar, and wherein said ring member further comprises a locking arrangement for locking the longitudinal casing edges in mutual abutment thereby closing the slit.

In at least one or more of the above embodiments said ring member is configured for being sealingly engaged to the external surface of the open end when said apparatus is fixedly secured to the handlebar. For example, said ring member may comprise at least one annular rim formed on an inner facing surface thereof that is in opposed relationship to the external surface when said apparatus is fixedly secured to the handlebar, said at least one annular rim being configured for being resiliently deformed on the external surface when the ring member is fixedly secured to an external surface.

In at least one or more of the above embodiments the external surface of the open end handlebar may be threaded, and said ring member comprises an inner-facing surface that is complementarily threaded with respect to the external surface of the open end of the handlebar, and wherein ring member is fixedly secured to the external surface of the open end of the handlebar by engaging the ring member threads with respect to the external surface threads.

In at least one or more of the above embodiments said ring member comprises at least one longitudinal stop configured for abutting against the edge of the open end of the handlebar when the apparatus is fixedly secured to the handlebar.

In at least one or more of the above embodiments ring member is configured for being selectively engaged with at least one storage unit at least when the storage unit is in a stowed position accommodated within the internal cavity in use of said apparatus. Optionally, said ring member is further configured for being selectively engaged with the at least one storage unit when the storage unit is in a deployed position at least partially outside of the internal cavity in use of said apparatus.

In at least some such embodiments, the apparatus may further comprise the at least one storage unit, wherein said at least one storage unit is selectively slidingly displaceable between said stowed position and said deployed position, and wherein said at least one storage unit is configured for allowing at least retrieval of at least one stored item therefrom at least in said deployed position. In some such embodiments, said at least one storage unit comprises a storage tray that is movably mounted to said ring member, said storage tray being selectively slidingly movable with respect to said ring member between said stowed position and said deployed position, said storage tray being configured for enabling items to be accommodated therein in said stowed position, and for enabling such items to be retrieved therefrom when said tray is in the deployed position. The ring member may comprise a first longitudinal stop and a second longitudinal stop, and wherein said storage tray comprises an elongate trough member, and a first tray end and a second tray end at opposite longitudinal ends of said trough member, wherein said trough member is configured for being slidingly displaced with respect to said passageway between said stowed position, wherein said first longitudinal end is in abutment with said first stop, and said deployed position, wherein said second longitudinal end is in abutment with said second stop. The first tray end may be configured for being displaced at least from said stowed position to said deployed position using at least one finger of a cyclist. The first tray end may optionally comprise a handle member that is selectively engageable with the at least one finger of the cyclist and configured for enabling said tray to be selectively pulled thereby to said deployed position. The first tray end may additionally or alternatively comprise a recess configured for enabling at least the tip of the at least one finger of the cyclist to be introduced therein, wherein in operation the tip of the at least one finger of the cyclist may be inserted into the recess to engage with said recess and thereby enable pulling the tray to the deployed position. In embodiments where the first tray end may additionally comprise a recess configured for enabling at least the tip of the at least one finger of the cyclist to be introduced therein, and said handle member may comprises a resilient strut member inwardly cantilevered from a periphery of said recess and projecting longitudinally forward thereof, wherein in operation the tip of the at least one finger of the cyclist may be inserted into the recess behind the strut member to engage with said recess and thereby enable pulling the tray to the deployed position via the strut member.

In at least some embodiments, said trough member has a generally semi-circular transverse cross-section along a longitudinal length of the trough member. Alternatively the trough member may have a generally polygonal transverse cross-section along a longitudinal length of the trough member. Additionally or alternatively, said trough member may have a uniform or non-uniform cross section along the longitudinal length thereof.

In at least some embodiments, the trough member may be configured for accommodating therein a plurality of cylindrical items, each cylindrical item having an external diameter generally complementary to an internal diameter of said trough member.

In at least some embodiments, said trough member comprises an external diameter generally complementary to an internal diameter of said passageway.

In at least some of the above embodiments or other embodiments, said trough member is configured for being reversibly curved with respect to an elongate direction thereof.

In at least some of the above embodiments or other embodiments, the bicycle handlebar has at least one bend in proximity to the open end thereof, and said trough member is at least sufficiently resilient to enable said trough member to be correspondingly curved when inserted into a part of the internal cavity corresponding to the at least one bend into the stowed position and to enable said trough member to be extracted from this part of the internal cavity to the deployed position.

In at least some of the above embodiments or other embodiments, the bicycle handlebar has at least one bend in proximity to the open end thereof, and said trough member is at least sufficiently bendable to enable said trough member to be correspondingly curved when inserted into a part of the internal cavity corresponding to the at least one bend into the stowed position and to enable said trough member to be extracted from this part of the internal cavity to the deployed position.

In at least some of the above embodiments or other embodiments, said trough member is formed with a plurality of longitudinally spaced corrugations configured for enabling said tray to reversibly bend.

In at least some of the above embodiments or other embodiments, said trough member comprises a removable cover member, said cover member being configured for covering the trough member when in the stowed position and during displacement of the tray from the stowed position to the deployed position. Optionally, said cover member is hingedly mounted and/or removably mounted to said trough member, wherein said apparatus is configured for enabling the cover member to hingedly open when said apparatus is in said deployed position to enable access to said trough member.

According to at least some embodiments of the invention, said ring member is further configured for enabling selectively disengaging of the at least one storage unit therefrom to facilitate retrieval of the at least one storage unit from the internal cavity in use of the apparatus. In at least some of these embodiments or other embodiments said ring member comprises a hook member configured for reversibly engaging with a distal end of the at least one storage unit. In at least some of these embodiments or other embodiments said hook member comprises a strut member comprising a strut base and a strut free end, said strut member being inwardly cantilevered from a periphery of an outer-facing annular edge of said ring member, which in use of the apparatus is outwardly displaced with respect to the open end of the handlebar, said strut member being configured for reversibly engaging with a first end of the at least one storage unit. In at least some of these embodiments or other embodiments said strut member radially projects from said strut base towards a longitudinal centerline of said ring member. In at least some of these embodiments or other embodiments said free end comprises an enlarged portion and a neck portion intermediate said enlarged portion and said strut base. In at least some of these embodiments or other embodiments said strut member is integrally formed on said ring member; alternatively said strut member is formed on a ring-shaped carrier that is configured for being affixed to said ring member. In at least some of these embodiments or other embodiments the first end of the at least one storage unit comprises a finger grip portion having an opening that is selectively releasably engageable with respect to said enlarged portion. In at least some of these embodiments or other embodiments said free end projects towards said longitudinal centerline and is spaced therefrom by a first spacing.

According to the first aspect of the invention there is provided an apparatus for a bicycle handlebar, the bicycle handlebar having an internal handlebar cavity in open communication with an open end of the handlebar, said open end having an edge and an external surface, the apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for at least enabling selective retrieval from the handlebar cavity of one or more items with one hand of a user at least while the bicycle is in motion, the one or more items being in a stowed position accommodated within said handlebar cavity (having been previously accommodated in the handlebar cavity via said ring member), and wherein said ring member is configured for remaining fixedly secured to the external surface at least during said retrieval. Optionally, the apparatus can be further configured in use for releasably affixing thereto said one or more items with said one hand or with another hand of the user, at least when each said item is in said stowed position, (at least while the bicycle is in motion), and wherein said ring member is configured for remaining fixedly secured to the external surface at least during said affixing. Additionally or alternatively, said apparatus can optionally be further configured for selectively and alternately opening and closing the open end of said handlebar, at least when said ring member is fixedly secured to the external surface; optionally, said ring member comprises an end cap member configured for being selectively closing and opening said ring member, wherein in use and said end cap member is in a closed position with respect to the ring member the open end of said handlebar is closed and access is denied to the handlebar cavity, and wherein in use and said end cap member is in an open position with respect to the ring member the open end of said handlebar is open and access is permitted to the handlebar cavity; further optionally said apparatus is configured for releasably affixing thereto said one or more items by releasably clamping an engagement portion of each respective said one or more items between said end cap member and said ring member when said end cap member is engaged to the ring member and when the respective said one or more items are in said stowed position; further optionally each respective said item comprises a finger grip portion, said engagement portion, and a housing defining an internal storage volume, in serial relationship; further optionally said apparatus is configured for releasably clamping said engagement portion of each respective said one or more items between said end cap member and said ring member while concurrently compelling the respective said finger grip portion to be in facing relationship with an external portion of said apparatus. Additionally or alternatively, said apparatus comprises a clamping arrangement comprising at least one clamp configured for enabling the respective said engagement portion to be automatically clamped to said apparatus when the end cap member is closed, and said engagement portion to be automatically unclamped from said apparatus when said end cap member is open thereby enabling the respective said item to be retrieved from said handlebar cavity by gripping the respective said gripping portion and pulling the respective item out of said handlebar cavity via the respective said gripping portion; optionally, said at least one clamp comprises a respective first clamping member in the form of a clamping tab that projects distally from a respective side of said end cap member, and a respective second clamping member in the form of a clamping pad provided on a respective side of said ring member; further optionally, a narrow opening is provided between clamping tab and said clamping pad when said end cap member is in the closed position, and wherein said narrow opening is configured for clamping therein said engagement portion of the respective said item while said engagement portion is folded over said clamping pad when said end cap member is in the closed position. Additionally or alternatively, said ring member optionally comprises a generally tubular casing having a first open casing end and a second open casing end, and a longitudinal passageway extending between said first open casing end and said second open casing end. Additionally or alternatively, said ring member is optionally configured for being sealingly engaged to the external surface of the open end when said apparatus is fixedly secured to the handlebar. Additionally or alternatively, said ring member optionally comprises at least one longitudinal stop configured for abutting against the edge of the open end of the handlebar when the apparatus is fixedly secured to the handlebar. Additionally or alternatively, the apparatus optionally further comprises at least one said item is in said stowed position accommodated within said handlebar cavity, each respective said item being in the form of a storage unit comprising a finger grip portion, an engagement portion, and a housing defining an internal storage volume, in serial relationship, wherein said engagement portion is configured to be releasably engaged to said apparatus while concurrently compelling the respective said finger grip portion to be in overlying relationship with an external portion of said apparatus; said finger grip portion is contiguous with said engagement portion and are in the form of any one of: a strip or material, a chord, a string, a chain; additionally or alternatively the storage unit is optionally configured having an absence of engagement arrangement for fixedly engaging the storage unit to the inside surface of the internal cavity.

According to the first aspect of the invention there is provided an apparatus for a bicycle handlebar, the bicycle handlebar having an internal handlebar cavity in open communication with an open end of the handlebar, said open end having an edge and an external surface, the apparatus being configured for being fixedly secured to the handlebar and for selectively enabling access to the handlebar cavity via said apparatus, wherein said apparatus is configured for use with at least one storage unit, said storage unit comprising a finger grip portion and a housing defining a storage volume, at least a part of said housing configured for being accommodated in a stowed position within said handlebar cavity, said storage unit further comprising an engagement portion intermediate said finger grip portion and said housing, and wherein said apparatus is configured for releasably clamping said engagement portion while said housing is in said stowed position and while concurrently compelling said finger grip portion to be in facing relationship with an external portion of said apparatus. The apparatus may optionally further comprise one or more elements and features of the other embodiments disclosed herein, mutatis mutandis.

In at least some of the above embodiments or other embodiments said apparatus is made from a weatherproof material.

In at least some of the above embodiments or other embodiments said bicycle handlebar has a drop-bar configuration.

In at least some of the above embodiments or other embodiments said bicycle handlebar has a conventional internal diameter of about 20.5 mm; alternatively bicycle handlebar has a diameter greater than the conventional internal diameter of about 20.5 mm. For example, the handlebar may have a diameter greater than about 20.5 mm by up to 5%, or up to 10%, or by up to 15%, or by up to 20%, or by up to 25%, or by up to 30% or by up to 35%, or by up to 40%, or by up to 45%, or by up to 50%, or by up to 60%, or by up to 70%, or by up to 80%, or by up to 90%, or by up to 100% or greater.

According to the first aspect of the invention there is provided a bicycle handlebar comprising an apparatus according to the first aspect of the invention as defined above, for example, mutatis mutandis. In at least some embodiments, said bicycle handlebar is a drop handlebar. In at least some of these embodiments or other embodiments, said bicycle handlebar has a conventional internal diameter of about 20.5 mm; alternatively, said bicycle handlebar may have a diameter greater than the conventional internal diameter of about 20.5 mm. For example, the handlebar may have a diameter greater than about 20.5 mm by up to 5%, or up to 10%, or by up to 15%, or by up to 20%, or by up to 25%, or by up to 30% or by up to 35%, or by up to 40%, or by up to 45%, or by up to 50%, or by up to 60%, or by up to 70%, or by up to 80%, or by up to 90%, or by up to 100% or greater.

According to the first aspect of the invention there is also provided a bicycle comprising a bicycle handlebar according to the first aspect of the invention as defined above, for example, mutatis mutandis.

It is to be noted that herein the expression “the bicycle is in motion” relates to the bicycle moving with respect to the ground while in contact therewith, i.e., while the bicycle is being propelled (typically by motive power provided to the bicycle by the rider via the pedals) and the bicycle wheels are turning over the ground in contact therewith.

According to a second aspect of the invention, there is provided storage unit (also referred to interchangeably herein as an item or as an article) configured for being retrievably accommodated in an inside of handlebar of a bicycle.

According to the second aspect of the invention there is also provided a storage unit configured for being selectively stowed in and retrieved from an internal cavity of a bicycle handlebar via an open end of the handlebar that is in open communication with the internal cavity, the storage unit comprising a housing having a proximal end and a distal end and further defining an internal storage volume, wherein said distal end comprises an elongate gripping portion configured for projecting to an outside of said bicycle handlebar, and wherein said storage unit is configured having an absence of engagement arrangement for fixedly engaging the storage unit to the inside surface of the internal cavity.

According to the second aspect of the invention there is also provided a storage unit configured for being selectively stowed in and retrieved from an internal cavity of a bicycle handlebar via an open end of the handlebar that is in open communication with the internal cavity, the storage unit comprising a housing having a proximal end and a distal end and further defining an internal storage volume, wherein said distal end comprises a finger grip portion, and wherein said storage unit is configured having an absence of engagement arrangement for fixedly engaging the storage unit to the inside surface of the internal cavity.

In at least some embodiments of the storage unit, said finger grip portion is configured for being accommodated fully within the internal cavity when said storage unit is stowed therein. In these or other embodiments of the storage unit, said finger grip portion is configured for being accommodated partially within the internal cavity when said storage unit is stowed therein.

In at least some of the above embodiments or other embodiments of the storage unit, said finger grip portion comprises a distal tab distally projecting from said distal end. In at least some such embodiments, the distal tab comprising an opening that is selectively releasably engageable with respect to a hook member, for example the free end of a strut member, that may be provided in said opening. For example, a periphery of said opening is deformable to allow reversible expansion of said opening. For example said opening is shaped as a cruciform having deformable flap portions, or may be star-shaped, or may have any other suitable form.

In at least some of the above embodiments or other embodiments of the storage unit, said housing is formed as an elongate generally cylindrical reservoir.

In at least some of the above embodiments or other embodiments of the storage unit, said housing, said distal end and said proximal end are integrally formed.

In at least some of the above embodiments or other embodiments of the storage unit, said housing has an absence of a discrete opening to said internal storage volume.

In at least some of the above embodiments or other embodiments of the storage unit, said storage unit may be configured for enabling access to said internal storage volume responsive to a destructive action carried out on said housing. For example, said storage unit may comprise a weakened structure in the vicinity of said internal storage volume. Optionally, said distal tab comprises a notch and is configured to be tearable from said notch to said internal storage volume when a shear force is applied between the distal tab and said housing.

According to the second aspect of the invention there is also provided a storage unit configured for being selectively stowed in and retrieved from an internal cavity of a bicycle handlebar via an apparatus, the bicycle handlebar having an internal handlebar cavity in open communication with an open end of the handlebar, said open end having an edge and an external surface, said apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for at least enabling selective retrieval from the handlebar cavity of said storage unit with one hand of a user at least while the bicycle is in motion, said storage unit being in a stowed position accommodated within said handlebar cavity and wherein said ring member is configured for remaining fixedly secured to the external surface at least during said retrieval. Optionally, the storage unit may comprise a housing having a proximal end and a distal end and further defining an internal storage volume, wherein said distal end comprises a finger grip portion, and wherein said storage unit is configured having an absence of engagement arrangement for fixedly engaging the storage unit to the inside surface of the internal cavity.

According to the second aspect of the invention there is also provided a storage unit configured for being selectively stowed in and retrieved from an internal cavity of a bicycle handlebar via an open end of the handlebar that is in open communication with the internal cavity, the storage unit comprising a housing having a proximal end and a distal end and further defining an internal storage volume, wherein said distal end comprises a finger grip portion, and wherein said storage unit is configured having an absence of engagement arrangement for fixedly engaging the storage unit to the inside surface of the internal cavity. The storage unit can comprise an engagement portion intermediate said finger grip portion and said housing; the engagement portion can be configured for being releasably clamped by the apparatus while said finger grip portion is configured to be concurrently to be in facing relationship with an external portion of said apparatus and said housing is concurrently in said stowed position; the engagement portion can be configured for being folded over said ring member and clamped thereon; the housing can be configured having an absence of a discrete opening to said internal storage volume; optionally, said storage unit can configured for enabling access to said internal storage volume responsive to a destructive action carried out on said housing; further optionally, said storage unit comprises a weakened structure in the vicinity of said internal storage volume. Alternatively, said storage unit comprises a closable opening for accessing said storage volume.

In at least some of the above embodiments or other embodiments of the storage unit, said internal storage volume is configured for storing consumable products.

In at least some of the above embodiments or other embodiments of the storage unit, said internal storage volume comprises a lining configured for conserving consumable products that may be stored therein.

In at least some of the above embodiments or other embodiments of the storage unit, said housing is made from a material configured for conserving consumable products that may be stored in said internal storage volume.

In at least some of the above embodiments or other embodiments of the storage unit, said internal storage comprises a consumable product. For example, said consumable product comprises an energy product configured for enhancing athletic performance of the human body. For example, said consumable product is in the form of a gel, liquid drink, “chewables”, “sports bar” and the like.

By way of non-limiting example, such gels may include energy gels as known in the art.

By way of non-limiting example, such liquid drink may include water, fruit juice, energy drink, coffee, and so on.

By way of non-limiting example, such “chewables” may include any edible or chewable matter, including toffees, sweets, chocolate drops and so on. For example such chewables may be of a size that are fully insertable into the mouth of the cyclist and are of a consistency that enable the cyclist to chew without the need to hold the remainder of the chewable.

By way of non-limiting example, such “sports bars” may include any edible matter in the form of a bar, including chocolate bars, cereal bars, and so on. For example such bars may be of a size that are at least partially insertable into the mouth of the cyclist and are of a consistency that enable the cyclist to bite a portion of the bar while holding the remainder of the bar.

At least some embodiments of present invention according to at least one of the above aspects provide a solution to the challenges associated with the retrieval by the cyclist of desired items, especially energy and nutritional products, particularly on the go when the rider is riding the bicycle at speed and requires to control the bicycle and/or maintain speed and/or change speed. These challenges are even more acute with road bikes, with the requirements for low bicycle weight, high cycling speeds and frequent intake of energy and nutritional products by the rider. Nevertheless, at least some embodiments of the present invention also provide for an apparatus that is also useful for longer term storage of items, e.g. non-perishable items, allowing simple storage and retrieval of the items, also when the bicycle is at a stop or parked.

At least some embodiments of present invention according to at least one of the above aspects provides access to substantially the full cross-section of the handlebar cavity, or close thereto, maximizing the potential for storing desired items therein and facilitating such stowage and retrieval thereof.

In at least some embodiments of present invention according to at least one of the above aspects, the apparatus of the invention may be factory-mounted to the bicycle handlebar, while in at least some other embodiments of present invention according to at least one of the above aspects the apparatus of the invention may be retrofitted to the bicycle handlebar.

Herein the term distal refers to a general forwards direction, i.e. the forward direction of the bicycle, while the term proximal refers to a general rearwards direction with respect to the forward direction of the bicycle.

While embodiments of the apparatus of the present invention are disclosed in the context of a bicycle, in particular a road bicycle, the invention also applies, mutatis mutandis, to other types of bicycles (for example hybrid bicycles, mountain bicycles, city bicycles, and so on) and also to similar road vehicles in which a handlebar or the like is used for steering and control and which comprises an internal handlebar cavity in open communication with an open end of the handlebar, the open end having an edge and an external surface. Thus, in a similar manner to that described herein for a bicycle handlebar, mutatis mutandis, the apparatus according to the first aspect of the invention is configured for being fixedly secured to the handlebar and comprising a ring member configured for being fixedly secured to the external surface of the open end of the handlebar and for selectively enabling access to the handlebar cavity via said ring member, wherein said apparatus is configured in use for facilitating at least retrieval of one or more items previously accommodated in the handlebar cavity via said ring member with one hand at least while the bicycle is in motion, and wherein said ring member is configured for remaining fixedly secured to the external surface at least during said retrieval. Other such road vehicles may comprise, for example, tricycles, wheelchairs, mopeds, motorcycles, and so on, each of which comprises, mutatis mutandis, the aforementioned internal handlebar cavity in open communication with an open end of the handlebar, the open end having an edge and an external surface.

Similarly, while embodiments of the apparatus of the present invention are disclosed in the context of a drop handlebar, in which the open end thereof is generally distal of the transverse portion thereof, they apply, mutatis mutandis, to drop handlebars in which the open end of the handlebar is generally proximal of the transverse portion, or indeed to any other type of handlebar, including straight handles bars, and so on, mutatis mutandis.

In at least some embodiments of the invention a rubber or cushioning layer already provided on the outer surface of the handlebar does not need to be removed for enabling the apparatus to be installed thereon.

Thus, according to at least some aspects of the invention, there is provided accessories for a bicycle or the like, and a method for accessing articles or items at least from a moving bicycle or the like.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an isometric view of an embodiment of the apparatus according to a first aspect of the invention mounted to a drop handlebar of a bicycle.

FIG. 2 is a partial cut-away view of a part of a drop-handlebar including the embodiment of FIG. 1.

FIG. 3 is a longitudinal cross-sectional isometric view of the embodiment of FIG. 1 with the cap member closed.

FIG. 4 is a longitudinal cross-sectional isometric view of the embodiment of FIG. 1 with the cap member opened.

FIG. 5 is an isometric view of the embodiment of FIG. 1 with the cap member closed.

FIG. 6 is an isometric view of the embodiment of FIG. 1 with the cap member opened.

FIG. 7 is longitudinal cross-sectional isometric view of the embodiment of FIG. 1 engaged to a handlebar and with the cap member opened.

FIG. 8 is another isometric view of the embodiment of FIG. 1 with the cap member opened.

FIGS. 9(a), 9(b), 9(c), 9(d), 9(e), 9(f) are back, front, side, other side, top and bottom side views, respectively, of the embodiment of FIG. 1 with the cap member closed.

FIGS. 10(a), 10(b), 10(c), 10(d), 10(e), 10(f) are back, front, side, other side, top and bottom side views, respectively, of the embodiment of FIG. 1 with the cap member opened.

FIG. 11 is an isometric view of a first embodiment of the storage unit according to a second aspect of the invention of the invention, particularly configured for use with the embodiment of the apparatus of FIG. 1.

FIGS. 12(a), 12(b), 12(c), 12(d), 12(e), 12(f) are back, front, side, other side, top and bottom side views, respectively, of the embodiment of FIG. 11.

FIG. 13 is a plan view of a sheet material for forming the embodiment of FIG. 11.

FIG. 14 is an isometric view of the embodiment of FIG. 1 with the cap member opened and the embodiment of FIG. 11 accommodated in a handlebar.

FIG. 15 is an isometric view of the embodiment of FIG. 1 with the cap member closed and the embodiment of FIG. 1 clamped thereto.

FIG. 16 is top isometric view of a second embodiment of the storage unit according to a second aspect of the invention of the invention, particularly configured for use with the embodiment of the apparatus of FIG. 1.

FIG. 17 side view of the storage unit of the embodiment of FIG. 16.

FIGS. 18(a) and 18(b) are top isometric and side views, respectively, of a second embodiment of the apparatus of the invention, with the cap member open; FIG. 18(c) is a cross-sectional side view of the embodiment of FIG. 18(a) taken along B-B.

FIG. 19 is an isometric view of a third embodiment of the apparatus of the invention.

FIG. 20 is an isometric view of the ring element of the embodiment of FIG. 19.

FIG. 21 is an isometric view of a second embodiment of the storage unit of the invention, particularly configured for use with the embodiment of the apparatus of FIG. 20.

FIG. 22 is an isometric cut-away view of the embodiment of FIG. 21 taken along A-A.

FIG. 23 is a side view of a third embodiment of the storage unit of the invention, particularly configured for use with the embodiment of the apparatus of FIG. 20, comprising two storage units according to the embodiment of FIG. 21 serially joined to one another, and in which a second of the two storage units has the extended tab portion thereof longitudinally aligned with the ring element of the embodiment of FIG. 19.

FIGS. 24(a) and 24(b) are top/side isometric and top views, respectively, of the embodiment fourth embodiment of the apparatus of the invention with the cap member open; FIG. 24(c) is a side view of the embodiment of FIG. 24(a); FIG. 24(d) is a cross-sectional side view of the embodiment of FIG. 24(b) taken along C-C.

### DETAILED DESCRIPTION OF EMBODIMENTS

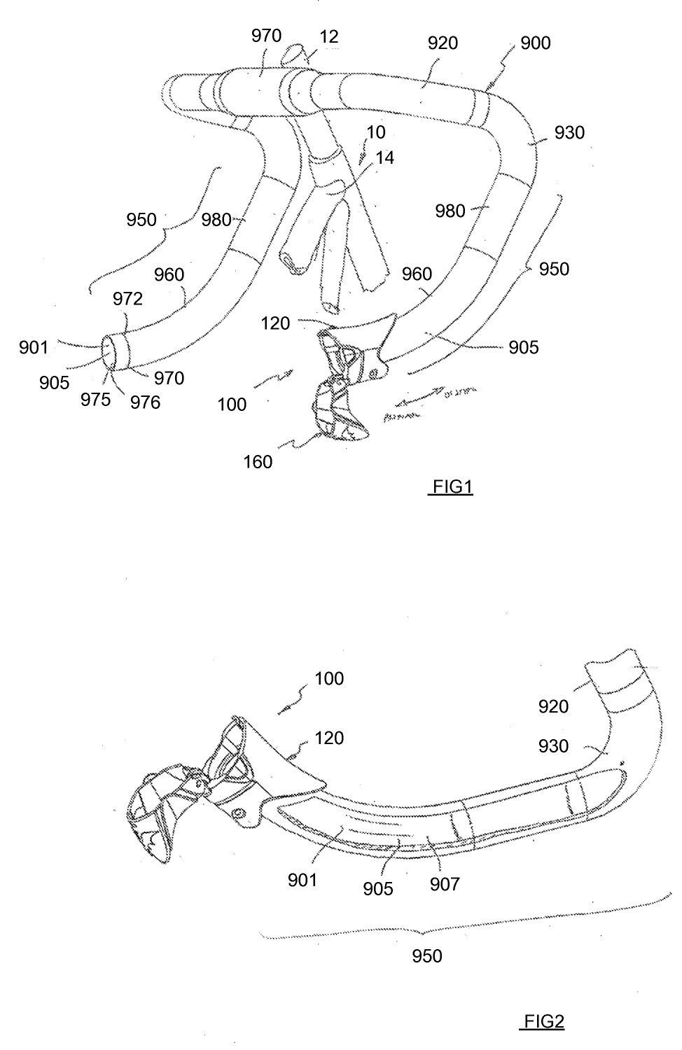

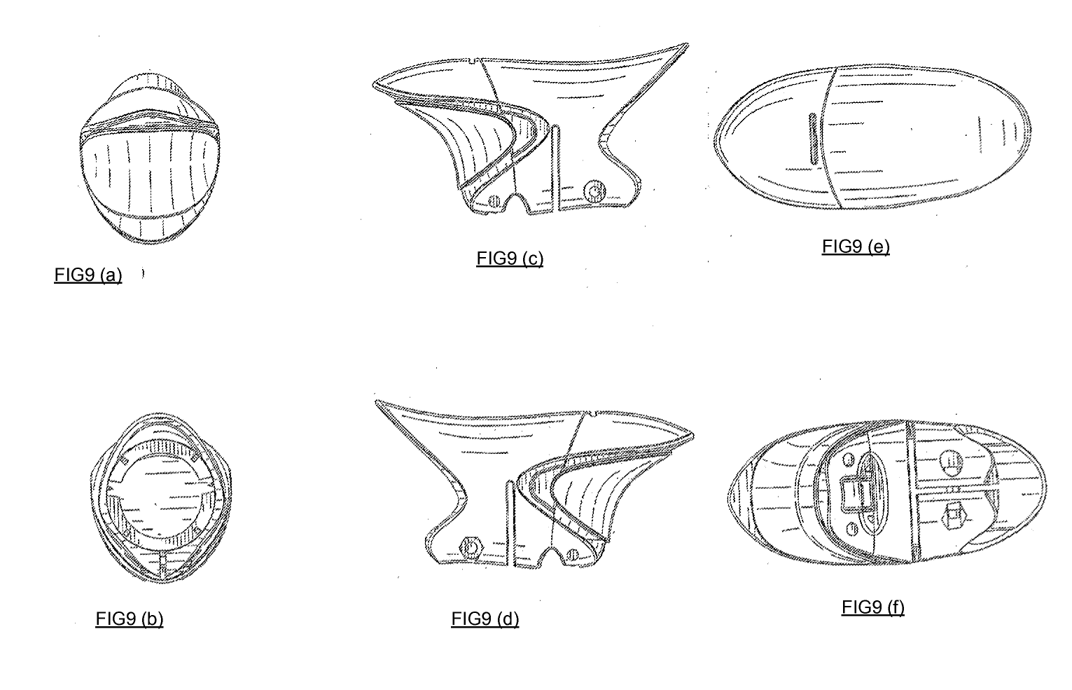

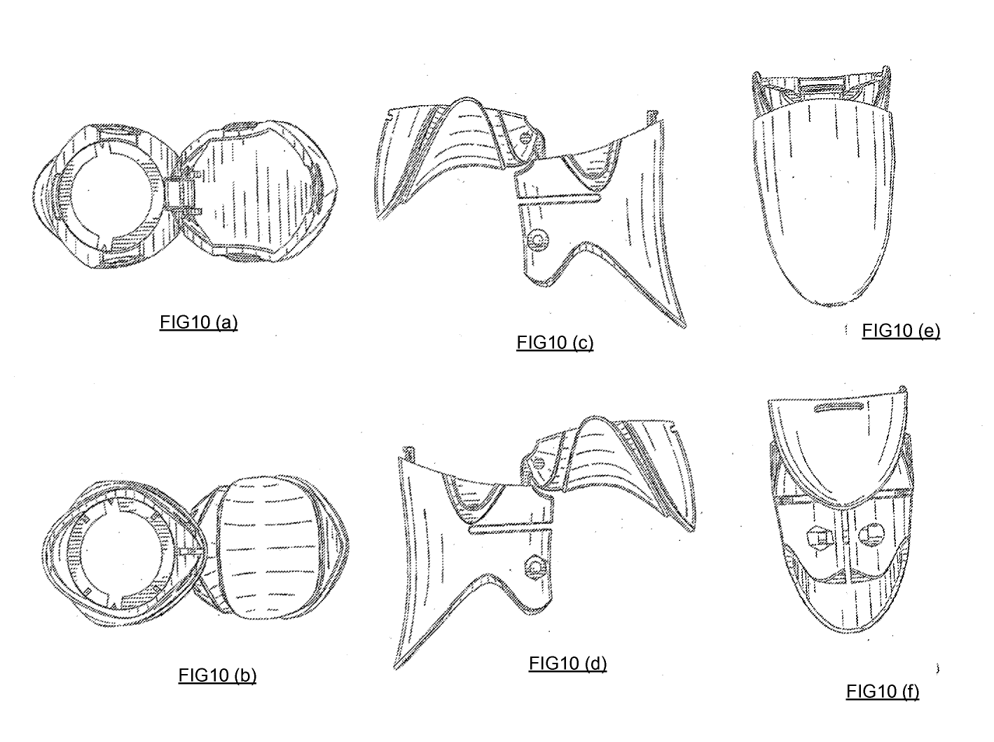

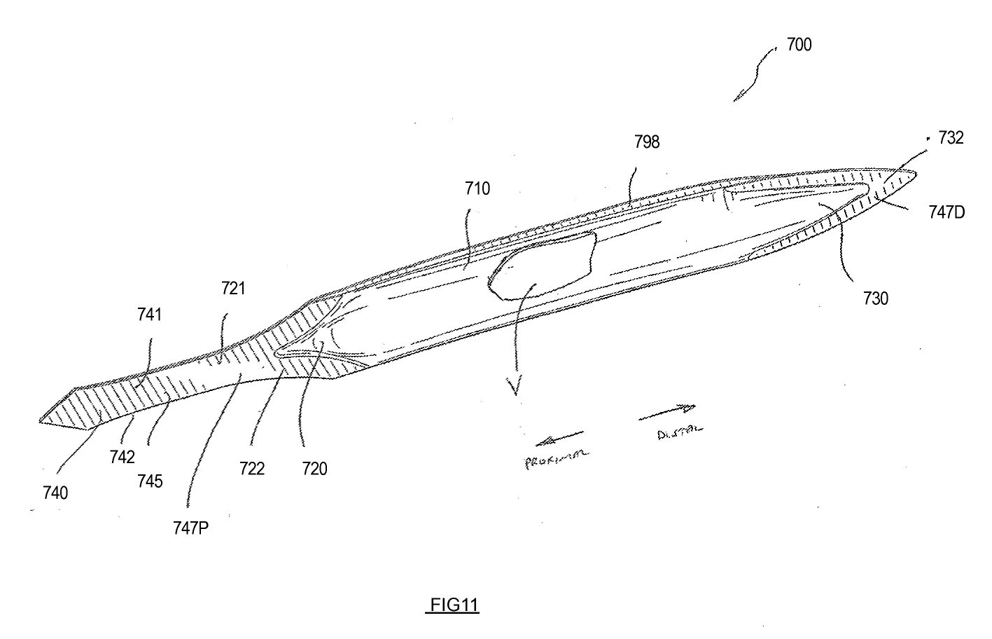

According to a first aspect of the invention, there is provided an apparatus (also referred to interchangeably herein as an accessory) for a bicycle handlebar. Referring to FIGS. 1 to 10(f), such an apparatus according to a first embodiment of the invention, generally designated 100, and is configured for being fixedly secured to a handlebar 900 of a bicycle 10.

Referring in particular to FIGS. 1 and 2, in this embodiment, the handlebar 900 is a drop handlebar commonly used for racing bicycles (referred to interchangeably herein as racing bikes, road bicycles or road bikes). The handlebar 900 has a generally tubular construction, and comprises a transverse portion 910 which is configured for being fixedly mounted to the steering strut 12 of the bicycle 10, which is in turn pivotably mounted to the bicycle frame 14 and allows the front wheel to be rotatably affixed to the steering strut. At each lateral end of the transverse portion 910 two substantially orthogonal elbow portions 920, 930 connect the transverse portion 910 to the respective hand grips 950. In this embodiment, the hand grips 950 are facing in a general aft direction with respect to the bicycle (i.e., the proximal direction with respect to the cyclist), though in alternative variations of this embodiment, the handlebar 900 may be turned by 180° with respect to the bicycle, so that the hand grips 950 face in a general forward direction with respect to the bicycle, and thus in such a case the terms proximal and distal generally take the opposite meanings to those used herein.

Each hand grip 950 comprises a curved portion 960 including the end portion 970 of the handlebar 900, and a mid-portion 980 between the curved portion 960 and the respective elbow portion 930. The end portion 970 comprises an open end 976 of the respective hand grip 950 and has a free edge 975.

The handlebar 900 is generally formed integrally as a single piece, though in alternative variations of this embodiment, the handlebar may instead be made of several portions suitably joined together.

The handlebar 900 comprises a handlebar cavity 901 that is in open communication with open end 976. While in this embodiment the cavity extends from the open end 976 of one hand grip 950 to the open end of the other hand grip, in alternative variations of this embodiment the cavity may be a partial cavity with respect to one hand grip 950, or comprises two separate partial cavities, one associated with each hand grip 950, in each case each partial cavity extending inwardly from the open end of the respective handgrip up to and including the respective mid portion 960, or up to and including the respective elbow portion 930, or up to and including the respective elbow portion 920, or up to and including part of the transverse portion 910. While in general, the handlebar 900 comprises a circular cross-section, the present invention is not limited thereto and is also applicable, mutatis mutandis, to handlebars of different cross-section, for example oval, polygonal and so on.

Thus, the handlebar 900 comprises at least one primary cavity 905 extending inwardly from the open end 976 of the respective handgrip 950 up to and including the inside of the respective curved portion 960 and the respective mid portion 980, and comprises an internal surface 907 defined by the inner surfaces of the respective curved portion 960 and the respective mid portion 980. The end 970 of the respective handgrip 950 comprises an external surface 972 extending from the respective edge 975.

While in at least this embodiment, one apparatus 100 is illustrated in FIGS. 1 and 2 as being fixedly to the end 970 of one handgrip 950, it will be appreciated that the handlebar 900 may optionally have two such apparatuses 100 fixedly attached thereto, one said apparatus 100 at each one of the two ends 970 of the handlebar.

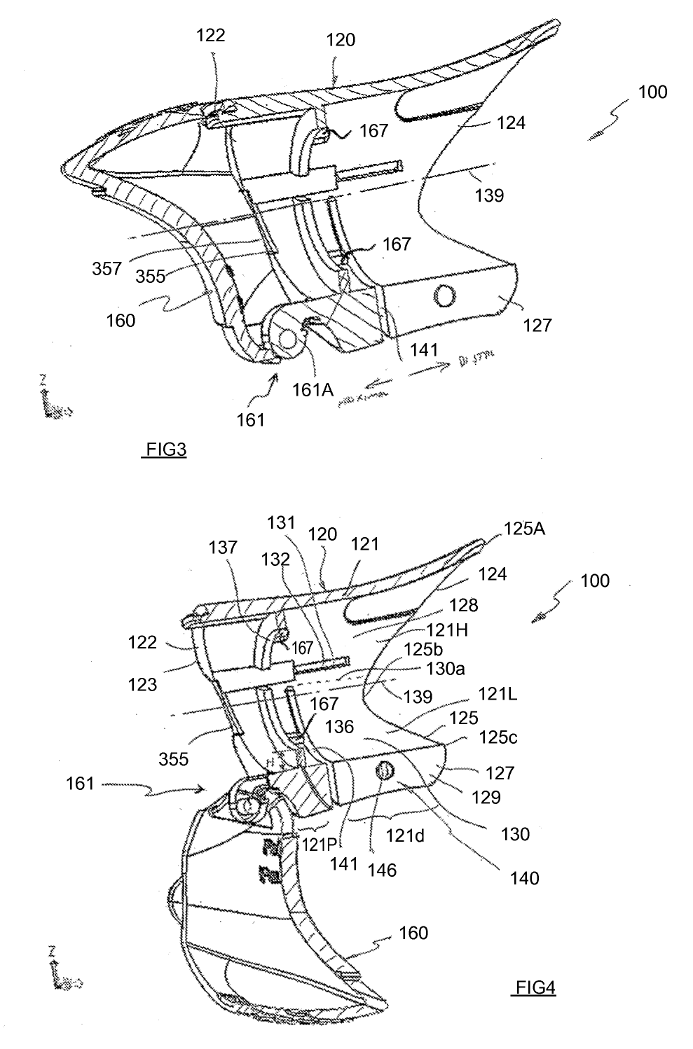

Referring also to FIGS. 3 to 6, the apparatus 100 comprises a ring member 120 configured for selectively enabling access to the handlebar cavity 901, in particular the primary cavity 905, via said ring member 120, wherein the apparatus 100 is configured in use for facilitating at least retrieval of one or more items (also referred to interchangeably herein as articles or storage units) previously accommodated in a stowed position in the handlebar cavity 901, in particular the primary cavity 905, via said ring member 120 with one hand at least while the bicycle is in motion, and wherein said ring member 120 is configured for remaining fixedly secured to the external surface 972 at least during such retrieval.

Ring member 120 comprises a generally tubular casing 121 having a proximal, generally annular, open casing end 122, a distal, generally annular, open casing end 124, and a longitudinal axis 139. A slightly scarffed proximal annular edge 123 circumscribes the proximal end 122, and a distal edge 125 circumscribes the distal end 124. In this embodiment, the distal edge 125 has a V-shaped profile when viewed from the side, in which the upper end 125a of the distal edge 125, projects the most distally, the distal edge 125 curving in a proximal direction to lateral end 125b and thereafter projecting distally again towards lower end 125c of the distal edge.125. As may be seen, upper end 125a of the distal edge 125 projects further distally than the lower end 125c. In alternative variations of this embodiment, the ring member may have a different form, for example a simple tubular configuration.

A longitudinal passageway or passage 136 is thus provided between the proximal casing end 122 and the distal casing end 124.

The casing 121 is formed with a transverse slit arrangement 141, in the form of a lower, generally semicircular, slit about midway between the proximal edge 123 and the lateral end 125c of the distal edge 125, essentially dividing the casing 121 into a proximal casing portion 121P and a distal casing portion 121D.

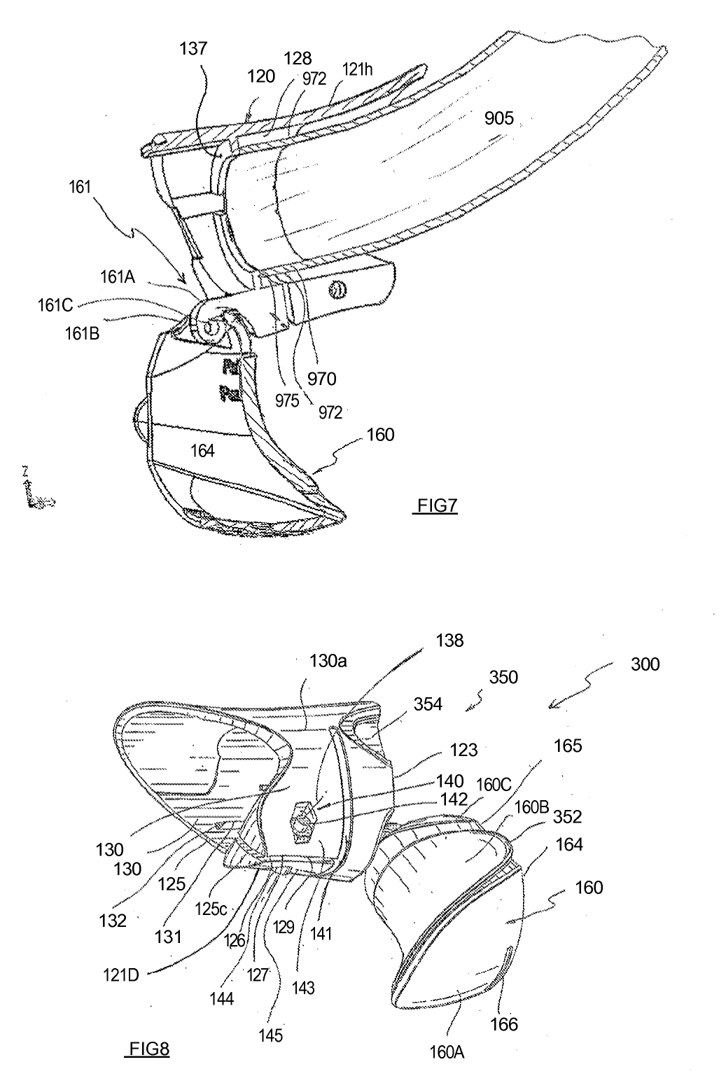

As best seen in FIG. 8, the casing distal portion 121D further comprises a generally longitudinal slit arrangement 129 extending between the lower end 125c of distal edge 125 and the transverse slit arrangement 141 to define opposed longitudinal distal casing edges 126, 127.

Referring in particular to FIG. 4, the casing distal portion 121D thus comprises an upper half 121U, joined to the casing proximal portion 121P, and a lower half 121L that is essentially split along slit arrangement 129, dividing the lower half into two resilient casing portions 130, each joined to the upper half 121U at a respective axis 130a. The two casing portions 130 can be reversibly pulled away from and pushed towards one another in a generally lateral direction by flexing about respective axes 130a, which are generally parallel to the longitudinal axis 139.

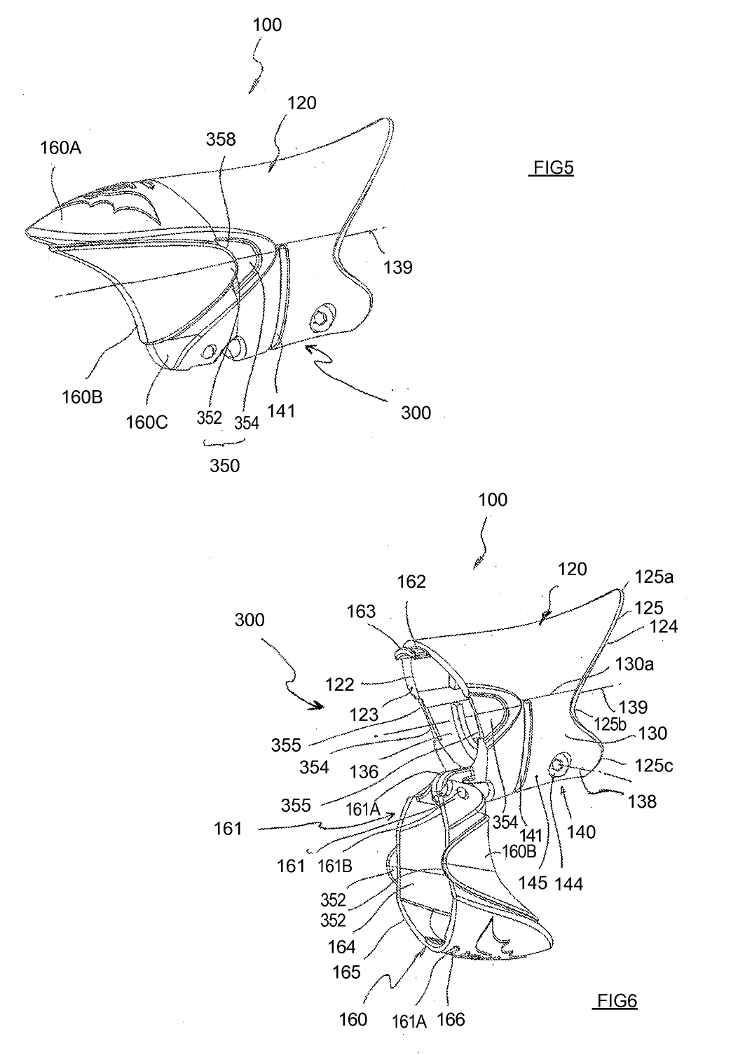

As best seen in FIGS. 4, 6, 8, a locking arrangement 140 is provided for reversibly locking the longitudinal casing edges 126, 127 in mutual abutment, thereby closing the slit arrangement 129 and reducing the size of the cross-section of passage 136. In this embodiment, the locking arrangement 140 comprises a locking screw 142 (FIG. 8), rotatably mounted about a transverse axis 138 to one casing portion 130 on flange 143, and engageable with nut 144 (FIGS. 6, 8) provided via the other casing portion 130 on opposed flange 145, the flanges 143, 145 having laterally aligned holes 146 to allow passage of the shank of the locking screw 142.

Referring in particular to FIGS. 4, 7 and 8, the casing distal portion 121D comprises an inner, generally cylindrical, surface 128 that is configured for being securely fixed directly or indirectly onto the external surface 972. In particular, the upper half 121U comprises longitudinal ribs 132 inwardly projecting from the respective portions of the inner surface 128. Each rib 132 has a cross-section that narrows from a relatively wide base at the inner surface 128 to a respective apex 131 distanced therefrom. The ribs 132 are resilient, or at least deformable, when a radial or lateral force is applied thereto. In alternative variations of this embodiment, the upper half 121U and/or the casing portions 130 may have semi-annular rims inwardly projecting from the respective portions of the inner surface 128, the rims also being resilient, or at least deformable, when a radial force is applied thereto.

Referring in particular to FIGS. 4 and 7, the casing proximal portion 121P comprises a longitudinal stop 137 in the form of a split annular rim, proximal of the transverse slit arrangement 141, that radially projects from inner surface 128 towards the longitudinal axis 139 to a height H.

Referring in particular to FIG. 7, to fixedly secure the apparatus 100 onto the respective end 970 of the handlebar 900, the locking arrangement 140 is unlocked or at least loosened, and the two casing portions 130 separated, by flexing about the respective axes 130a to increase the effective internal diameter of the casing distal potion 121D to a diameter substantially greater than the external diameter of the end 970. Alternatively, the casing portions 130 may be biased to assume such an open position when the locking arrangement 140 is unlocked or at least loosened.

The open casing distal portion 121D is then placed in longitudinal overlying relationship with the respective end 970, until the longitudinal stop 137 is in abutment with the respective edge 975. Thereafter the two casing portions 130 are brought together so that the longitudinal casing edges 126, 127 are brought into mutual abutment and locked in place via the locking arrangement 140. Concurrently, the inner surface 128 is brought closer to outer surface 972, and ribs 132 are deformably and/or resiliently abutted onto the surface 972 to form a pressure and/or friction fit therewith, thereby fixedly securing the ring member 120 onto the end 970.

In this embodiment the inside diameter of the longitudinal stop 137 is preferably not less than the internal diameter of the end 970, and not greater than the external, diameter of the end 970. Thus, the stop 137 is in overlying relationship with the edge 975 of end 970. In alternative variations of this embodiment, the stop 137 may be replaced with radial protrusions radially projecting from inner surface 128 towards the longitudinal axis 139, to a height H, for example.

As best seen in FIGS. 3 and 4, optional anchors in the form of longitudinal ribs 167 that project distally from the distal end of the longitudinal stop 137 and are inwardly projecting from the respective portions of the inner surface 128 of the casing proximal portion 121P. The ribs 132 have a rounded distal end and are configured for being embedded onto a rubber layer or other cushioning layer often found covering the outer surface 972 (and often in the form of tape wound on the outer surface 972), and/or for being deformed and thereby clamping in place the edge 975 in abutment to the longitudinal stop 137. Thus, in at least some embodiments of the invention according to the first aspect of the invention, such a rubber or cushioning layer already provided on the outer surface of the handlebar does not need to be removed for enabling the apparatus 100 to be installed thereon.

When the apparatus 100 is fixedly secured to the handlebar 900, the ring member 120 provides access to the respective primary cavity 905 via open casing end 122, and furthermore provides protection from edge 975, which often is a relatively sharp edge.

The apparatus 100 further comprises an end cap member 160, which in this embodiment is hingedly connected to the ring member 120 via lower hinge arrangement 161. Referring in particular to FIGS. 6 and 7, hinge arrangement 161, in this embodiment, comprises a distal hinge bracket 161A projecting proximally from the lower part of edge 123, a proximal hinge bracket 161B formed on the corresponding lower part of the end cap member 160, and a hinge pin 161C pivotably interconnecting between distal hinge bracket 161A and the proximal hinge bracket 161B. In alternative variations of this embodiment, the hinge arrangement may instead comprise, for example, a film hinge, or any other suitable hinge arrangement.

End cap member 160 is configured for selectively and reversibly closing the open casing end 122, in particular using only one hand, and at least when the bicycle is in motion.

Referring in particular to FIGS. 5, 6 and 8, end cap member 160 comprises an upper portion 160A, having the general form of a heraldic shield when viewed from above (and in fact may optionally be decorated with a logo, trademark, alphanumeric characters (for example the name and/or other particulars of the bike owner), for example), a lower portion 160C including the proximal hinge bracket 161B, and a saddle-shaped middle portion 160B. The end cap member 160 defines an internal cavity 164 and a peripheral distal edge 165, configured for abutting onto proximal edge 123 of the ring member 120.

Referring in particular to FIGS. 6 and 8, ring member 120 comprises a locking tab 162 projecting distally from the distal edge 123 at an upper position thereon. The locking tab 162 is configured for locking with respect to slot 166 provided in the upper portion 160A of end cap member 160 when the end cap member 160 is in the closed position with respect to the ring member 120, illustrated in FIG. 5, for example. The locking tab 162 is resilient and comprises an engagement end 163 that is configured for engaging with respect to the slot 166 to provide a “click fit” closure for the end cap member 160 with respect to the ring member 120. By applying a downward and proximal pressure on the upper portion 160A, the engagement end 163 may be “unclicked” from the slot 166, enabling opening the end cap member 160 with respect to the ring member 120 with one finger of one hand of the cyclist, typically the thumb. The shield-shaped upper portion 160A is thus configured to facilitate applying pressure by the tip of a finger, typically a thumb, so that the end cap member 160 may be clicked to the closed position with the finger (typically thumb) of one hand of the cyclist, at least when the bicycle is moving.

(It is to be noted that for the sake of clarity the terms proximal and distal when applied to the end cap member are generally associated with the closed position thereof)

The apparatus 100 is further configured for facilitating securing and retrieval of an item that is configured for being reversibly accommodated in the primary cavity 905 and having an elongate proximal gripping portion (also referred to interchangeably herein as the finger grip portion) that projects from the main body or housing of the item that defines its respective internal storage volume. A clampable engagement portion is provided intermediate the proximal gripping portion and the housing, and thus the gripping portion, the engagement portion and the housing are in serial relationship.

As will become clearer herein, apparatus 100 comprises a clamping arrangement 300 that enable the aforesaid engagement portion to be automatically clamped to the apparatus 100 when the end cap member 160 is closed while concurrently compelling the gripping portion to be in facing relationship with an outside of the apparatus 100 and the housing is in the stowed position, and for the aforesaid engagement portion to be automatically unclamped from the apparatus 100 when the end cap member 160 is opened, allowing the item to be retrieved from the respective primary cavity 905 by gripping the gripping portion and pulling the item out of the respective primary cavity 905 via the gripping portion.

In the illustrated embodiment, the clamping arrangement 300 comprises a pair of clamps 350, either one of which may be used for engaging one or more such items. Each clamp 350 further comprises a respective first clamping member (comprised on the end cap member 160) that is configured for selectively clamping with respect to the respective second clamping member (that is comprised on the ring member 120) to clamp therebetween the engagement portion of the respective item or items.

Referring to FIGS. 5, 6 and 8 in particular, each clamp 350 comprises a respective first clamping member in the form of a clamping wing or clamping tab 352 that projects distally from the respective side of the saddle-shaped middle portion 160B, beyond the edge 165 of the end cap member 160. Further, each clamp 350 comprises a respective second clamping member in the form of in the form of a clamping pad 354 recessed on the side of outer wall of the casing 121.

As best seen in FIGS. 3 and 4, the proximal edge 355 of each recess is indented distally with respect to the proximal edge 123, forming a narrow opening 357 when the end cap member 160 is in the closed position, and is thereby configured for allowing the aforesaid gripping portion of the stored item to project from and inside of the ring member 120, for the engagement portion to be folded over the edge 355, and for the folded gripping portion to assume an overlying or facing position with respect to the clamping pad 354 when the end cap member 160 is in the open position. When the end cap 160 is closed onto the ring member 120, each clamping tab 352 overlies onto the respective clamping pad 354 and provides a small gap 358 (FIG. 5) therebetween to enable one or more engagement portions of respective items to be clamped therebetween.

In alternative variations of this embodiment, the end cap member may have a different form, for example a simple tubular or disc-like configuration, and including suitable clamping arrangement compatible with the ring member, for example.

It is to be noted that by being fixedly secured to the outer surface 972 of the handlebar end 970, the open casing end 122 allows open communication with substantially the full transverse cross-section of the handlebar cavity 901, in particular substantially the full transverse cross-section of primary cavity 905. An item having an external diameter up to just under the internal diameter of the primary cavity 905 and having a proximal gripping portion may be stored in the primary cavity 905 for later retrieval by the cyclist, while ring member 120 remains fixedly secured to the handlebar 900, and thus does not require dismantling of the apparatus 100 or part thereof in order to access the stored item.

Thus, in operation of this embodiment, such an item may be stored within the primary cavity 905, such that the gripping portion of the item is projecting distally from gap 358 when the end cap member 160 is closed.

Optionally, a permanent or semi-permanent distal stop (not shown) may be provided within the primary cavity 905, unconnected to the apparatus 100, to prevent the item from being introduced further into the primary cavity 905. The end cap member 160 may be closed, thereby clamping the item to the apparatus while the main body (i.e. housing) of the item is accommodated in primary cavity 905. When the cyclist wishes to retrieve the item, the cyclist can click open the end cap member 160 using a finger or thumb to press the upper portion 160A in a generally proximal/downward direction, thereby unclamping the engagement portion of the item, which the cyclist can grasp the gripping portion with a finger and thumb of the same hand that was used for opening the apparatus 100.

Thus, retrieval of the stored item from the primary cavity 905 may be achieved by one hand of the cyclist even when the bicycle is in motion, since cyclist are routinely capable of controlling a bicycle with only one hand (the other hand in this case), even when cycling at great speed. Furthermore, since during such retrieval the cyclist's hand remains close to the respective handlebar end 975, it enables the cyclist to regain control of the bicycle with this hand almost instantaneously, should he need to, and moreover there is no significant danger of this hand colliding with an adjacent cyclist, pedestrian or other structure, and thus enables the cyclist to retrieve the item even when there are other cyclists in close proximity.

The structure of the apparatus also allows the cyclist to close the primary cavity 905 by clicking closed the end cap member 160 onto the ring member 120, by first pivoting the end cap member 160 into alignment with the ring member 120 with one hand, and then pushing the end cap member 160 to click close with a finger or thumb. Thus, closure of the apparatus can also be performed by the cyclist with one hand and when on the go.

It is to be noted that in alternative variations of this embodiment, the end cap member 160 may be omitted from the apparatus 100, and the ring member 120 remains open. In such cases the stored item may be held in the stowed position inside the primary cavity 905 until it is retrieved, and reversibly clamped or otherwise reversibly affixed to the ring member 120. For example, hooks may be provided on the outer surface of the ring member 120, and the gripping portion of the item may have a hole, or one may be formed therein by impaling the gripping portion onto a hook. To retrieve the item, the user can unhook the gripping portion from the hook, or simply tear off the gripping portion from the hook, and pull out the item. Alternatively, for example, the ring member 120 may comprise a hand clamp mounted to or separate from the ring member 120, and the hand clamp is configured for clamping the aforesaid gripping end of the item, and for enabling unclamping thereof using only one hand.

In the first embodiment and in at least some alternative variations thereof, the apparatus 100 is configured for being fixedly secured to a handlebar having a conventional inner diameter of 20.5 mm, and is thus retrofittable onto many existing conventional handlebars and/or may be factory-fitted onto new bicycles having handlebars of such conventional inner diameter.

In at least some other alternative variations of this embodiment, though, the handlebar may be manufactured in a size greater than the aforementioned conventional size, for example having the internal diameter larger than the conventional 20.5 mm diameter. For example, such an increased internal diameter may be up to 5%, 10%, 15%, 20%, 25%, 30%, 35%, 40%, 45%, 50%, 60%, 70%, 80%, 90%, 100% larger, or larger, providing respective internal diameters of 21.525 mm, 22.55 mm, 23.575 mm or 24.6 mm, 25.625 mm, 26.65 mm, 27.675 mm, 28.7 mm, 29.725 mm, 30.75 mm, 32.8 mm, 34.85 mm, 36.9 mm, 38.95 mm, 41 mm, or greater, respectively. In these or other alternative variations of this embodiment, though, the handlebar may be manufactured with, or may be modified to have, an external screw thread, bayonet fit, or other engagement means on the external surface 972, that is complementary to an internal thread, bayonet mount or other complementary engagement means provided on the ring member 120, enabling the ring member to be fixedly secured to the external surface 972 of the end 970 by simple hand manipulations, optionally without the need for tools; in such cases the ring member 120 may omit the locking arrangement 140.

The apparatus 100 may be made from any suitable materials or combination of materials, including plastics, polymers, composites, metals, wood and so on.

According to a second aspect of the invention, there is provided an item (also referred to interchangeably herein as an article) configured for being retrievably accommodated in an inside of handlebar 900 of a bicycle 10.

Referring to FIGS. 11 to 13, a first embodiment of an item in the form of a storage unit, designated with the reference numeral 700, is per se novel, and while particularly configured for use with the apparatus according to the illustrated embodiment or alternative variations thereof, according to the first aspect of the invention, may be used with other apparatuses that may be configured for being fixed to the end of the handlebar 900, mutatis mutandis, and/or may be used as a stand-alone storage unit that may be accommodated, for example, in a pocket or elsewhere.

The storage unit 700 is configured for being selectively stowed in and retrieved from the internal cavity 901, in particular the primary cavity 905, of the bicycle handlebar 900 via the open end 976 of the handlebar 900 that, as has already been discussed, is in open communication with the internal cavity 901, in particular primary cavity 905. The storage unit 700 comprises an elongate, generally tubular housing 710 having a proximal end wall 720 and a distal end wall 730, and further defines an internal storage volume V therein. The storage unit 700 is configured having an absence of engagement arrangement for fixedly engaging the storage unit to the inside surface, i.e. internal surface 907, of the internal cavity 905.

The distal end wall 730 fishtails distally to a short pointed distal tab 732. Proximal end wall 720 fishtails proximally to an elongate pointed proximal tab 722 that is centrally disposed with respect to the proximal end wall 720.

The proximal tab 722 has a gripping portion 740 at the proximal end thereof and an engagement portion 721 at a distal end thereof next to the housing 710. The gripping portion 740 is configured for projecting to an outside of the handlebar 900 when the tubular housing 710 is accommodated fully or partially within the internal cavity 901, in particular the primary cavity 905 (for example, a proximal part of the tubular housing 710 may be accommodated in the proximal casing portion 121P and possibly also in the internal cavity 164 of the end cap member 160). The gripping portion 740 is contiguous with engagement portion 721, and together are in the form of an extended tab portion 745, which is contiguous with and proximally projecting from the proximal tab 722 in FIG. 11, for example. The proximal end wall 720 is, in this embodiment, tearable from the tubular housing 710 responsive to the application of a suitable force, for example a suitable shear force, to allow access to the volume V, and thus to the contents thereof.

The storage unit 700 is thus constructed so that such a shearing force or other force may be generated, for example, by holding the housing 710 with one hand, and the extended tab portion 745 or proximal tab 722 with the other hand or the teeth, and pulling the housing 710 away from the extended tab portion 745 or proximal tab 722. In particular, the materials from which the storage unit 700 is constructed may be chosen to ensure that an average force generated in this manner is sufficient to tear off the extended tab portion 745 together with end wall 720 away from the tubular housing 710.

In alternative variations of this embodiment, the storage unit comprises a weakened structure in the vicinity of the internal storage volume, for example a weakened or perforated line or a notch may be provided between the proximal end wall 720 and the tubular housing 710.

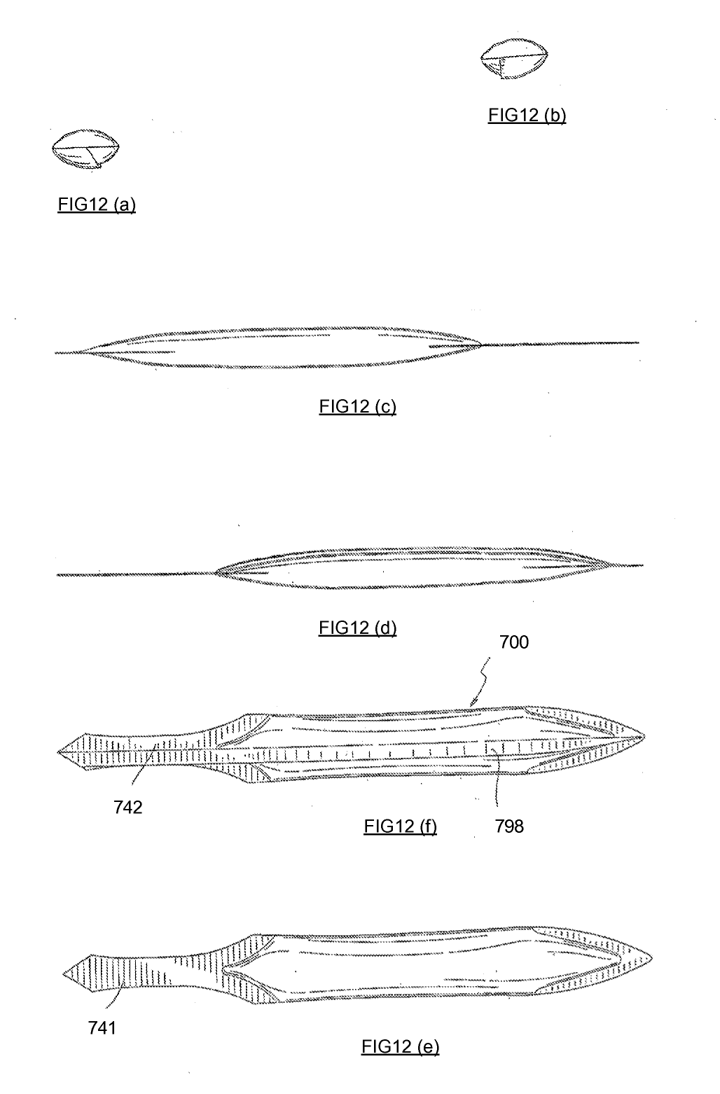

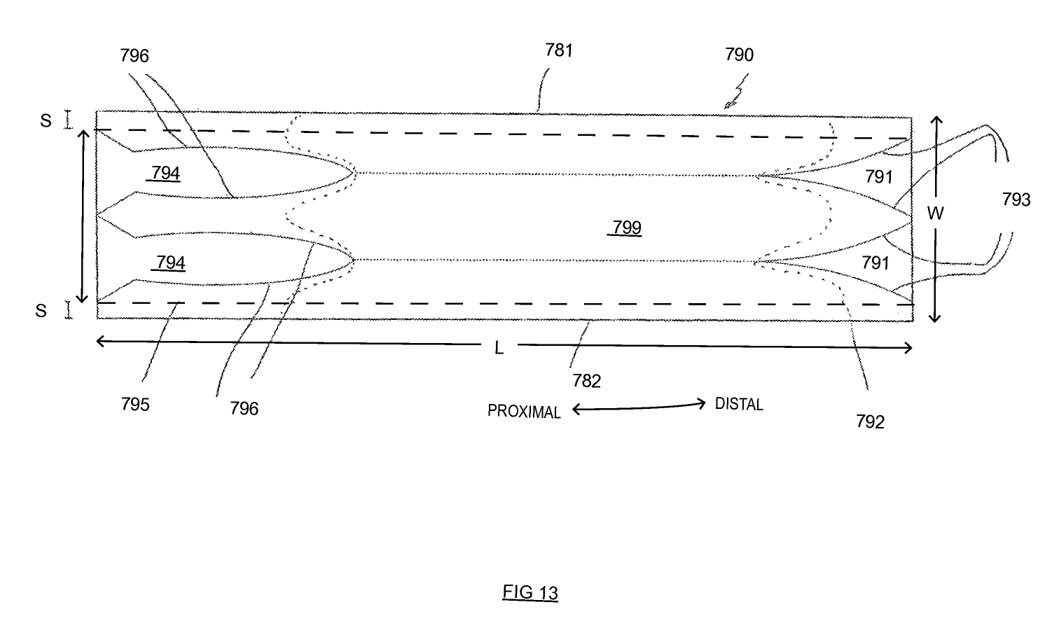

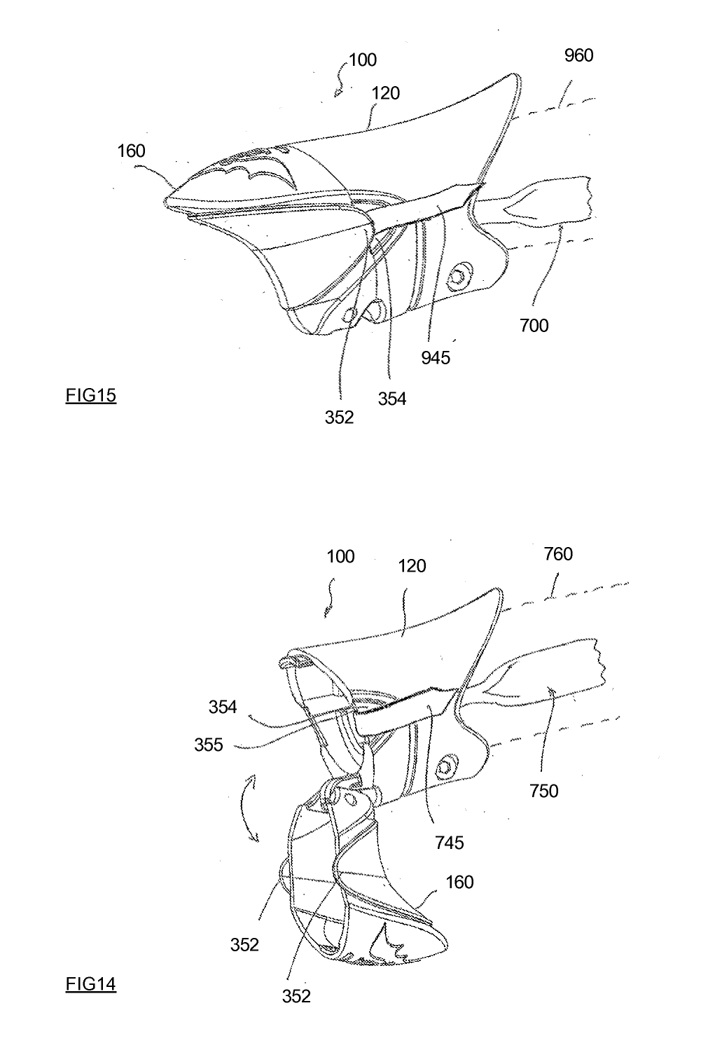

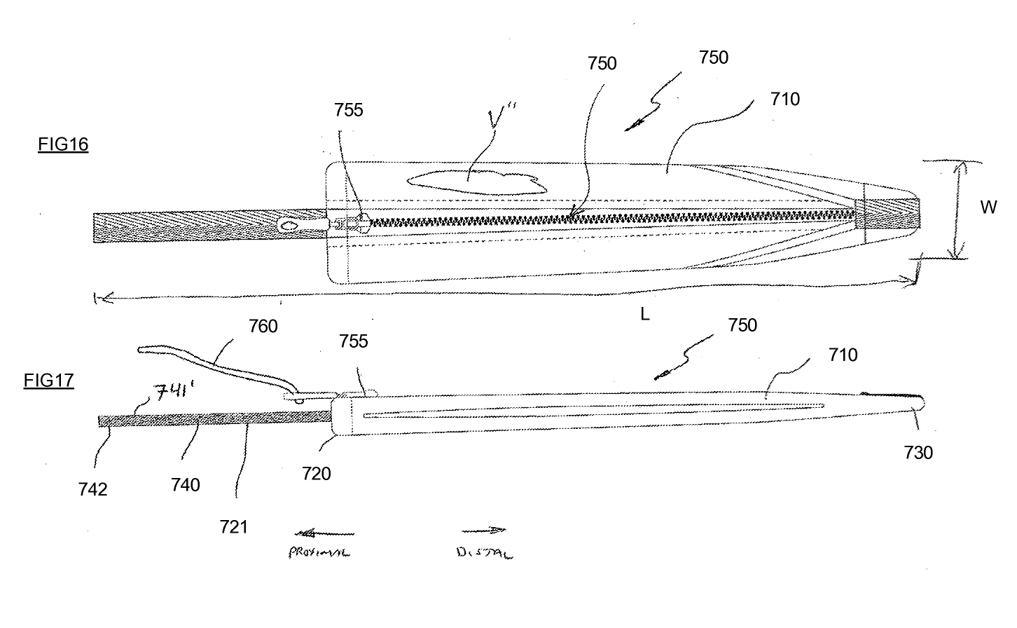

Gripping portion 740 in the form of extended tab portion 745 comprises an upper face 741 and a lower face 742 (FIGS. 11, 12(e), 12(f)), each being dimensioned to be graspable by one or another of a finger and thumb of one hand to enable the cyclist to retrieve the storage unit 700 with one hand even while cycling, while at the same time being sufficiently small to fit partially within the cavity 901, or at least primary cavity 905, when the storage unit 700 is in the stowed position.

In this embodiment, the storage unit 700 is formed as an integral unit, and thus the housing 710, distal end wall 730 and said proximal end wall 720 are integrally formed, together with the proximal tab 722, and extended tab portion 745. In alternative variations of this embodiment, the storage unit may instead be formed in several parts suitably joined together.

In particular, and referring also to FIG. 13, the storage unit 700 may be configured as a sachet, formed from a rectangular sheet 790 of suitable material such as for example a suitable laminate.

Sheet 790 has a length L and width W, a distal end 792 and a proximal end 795. Generally triangular-shaped distal portions 791 (with two curved sides) are cut out from the distal end 792 to define edges 793 that correspond to the edges of distal tab 732. Similarly, generally ogive-shaped proximal portions 794 are cut out from the proximal end 795 to define edges 796 that correspond to the edges of the proximal tab 722 and extended tab portion 745. The remaining form 799 of the sheet 790 after the distal portions 791 and the proximal portions 794 are removed is sealed along a longitudinal fin seal 798 (see FIGS. 11 and 12(f)) by sealing together width s of longitudinal edges 781, 782 of the form 799, to form a generally cylindrical structure. Then, the distal end of the form 799 is sealed at a distal transverse seal 797D, defined by edges 793, to form distal tab 732. Similarly, the proximal end of the form 799 is sealed at a proximal transverse seal 797P, defined by edges 796, to form proximal tab 722 and extended tab portion 745. Prior to forming one or the other of the proximal transverse seal 797P or the distal transverse seal 797D, the internal volume V may be filled with suitable contents, for example.

Such sealing may include, by way of non-limited example, one or more of heat welding, ultrasonic welding, suitable adhesives, and so on.

By way of non-limiting example, length L can be about 220 mm and width W can be about 60 mm; width s of each one of longitudinal edges 781, 782 can be about 5 mm.

In this embodiment, the internal storage volume is configured for storing consumable products, and the internal storage volume V can be lined with a lining configured for conserving consumable products that may be stored therein. In alternative variations of this embodiment, the storage unit 700, in particular the housing 710, is made from a material configured for conserving consumable products that may be stored in the internal storage volume.

In at least this embodiment, the storage unit 700 is made from disposable materials and is disposed of after use.

According to this embodiment, the internal storage volume V comprises a consumable product, for example an energy product configured for enhancing athletic performance of the human body. In this embodiment, the housing 710 is formed as an elongate generally cylindrical reservoir, for storing a liquid or gel, and the consumable product is in the form of a drink or gel, respectively. Many examples of such drinks and gels are known in the art and are generally suitable for being stored in the storage unit 700.

In alternative variations of this embodiment, the housing 710 may be configured for storing non-flowable matter, such as solids, and such consumable products may be in the form of “chewables”, “sports bars” and so on as known in the art. In such embodiments, when the extended tab portion 745 is ripped off, it fully opens up the internal storage volume, and enables the solid consumable to be removed from the package.

Furthermore, in this embodiment, the storage unit 700, and in particular the housing 710, has an absence of a discrete closable opening to the internal storage volume or a closure therefor, and thus once opened remains open.

Referring also to FIGS. 14 and 15, the storage unit 700 is particularly configured for being selectively engaged and disengaged with respect to the apparatus 100, in particular for being selectively clamped and unclamped with respect to one or another of the two clamps 350 of the apparatus 100.

In order to engage the storage unit 700 with the apparatus 100 in the stowed position, the end cap 160 is opened, as disclosed above, and the storage unit 700 is inserted into the primary cavity 905 such that the extended tab portion 745 projects proximally from the open proximal casing end 122. The tab portion 745, in particular the engagement portion 721, is then folded over the proximal edge 355 of one recess 354, so that at least a part of the tab portion 745 including the gripping portion is now pointing in a general distal direction and is in general overlying relationship or in facing relationship with an external surface of the ring member 120, i.e. with respect to an outside of the apparatus 100. Thereafter, the end cap 160 may be closed, and the respective clamping tab 352 automatically clamps the tab portion 745, i.e. the engagement portion 721, onto the clamp recess 354, while compelling the gripping portion to remain outside of the apparatus 100

While such stowage of the storage unit 700 may be accomplished with one hand and while on the go, it is envisaged that the cyclist will normally stow the storage unit 700 in the handlebar 900 prior to commencing cycling or whenever else the bicycle is at rest.

Retrieval and use of the storage unit 700 may be accomplished by the cyclist using one hand, and also while cycling, for example as follows. First, the end cap 160 is opened with one hand, as already disclosed above. The extended tab portion 745 (i.e. the gripping portion) is grasped by one hand, typically via a finger and thumb of the cyclist's hand, and the storage unit 700 may be pulled out by the cyclist while still grasping the extended tab portion 745. The storage unit 700 can be manipulated so that the hand (the same hand, or alternatively the storage unit 700 can be transferred to the other hand instead) is now holding the housing 710, and the extended tab portion 745 is free. The extended tab portion 745 may now be gripped by the teeth of the cyclist, for example, and a shearing force induced between the extended tab portion 745 and the remainder of the storage unit 700, by pulling the storage unit 700 away so that the extended tab portion 745 is and proximal end 722 is ripped off or torn open from the storage unit 700. Thus, the storage unit 700 is configured for enabling access to the internal storage volume V responsive to a destructive action carried out on the storage unit.

The internal storage volume V is now in communication with the outside of the storage unit 700, and allows the user to suck out any fluid contents or gel contents (or indeed any other type of contents therein, for example powder, solids, etc) thereof, for example via oral suction applied to the opening 728, or by squeezing the contents out by squeezing the housing 710.

Once the storage unit 700 is removed, the end cap 160 may be closed again if desired.

It is readily understood that the storage unit 700 may be clamped to one or the other of the two clamps 350.

It is also readily understood that, depending on the specific dimensions of the storage unit 700, more than one storage unit 700 may be accommodated in the within the internal cavity 901, in particular the primary cavity 905, and that one or more such storage units 700 may be clamped by each one of the two clamps 350, for example in juxtaposed or overlying relationship. In such cases, the user may choose to retrieve all the storage units 700 at the same time, or to retrieve one storage unit at a time, inbetween closing the apparatus 100 via end cap member 160 while mainlining clamped the remaining storage units with respect to the apparatus 100.

Referring to FIGS. 16 and 17, a second embodiment of said item, also in the form of a storage unit, is designated with the reference numeral 700′, and is similar to the first embodiment of storage unit 700, with some differences, mutatis mutandis, as will become clearer hereinbelow.

As with the first embodiment, the storage unit 700′ is also per se novel, and while particularly configured for use with the apparatus according to the illustrated embodiment or alternative variations thereof, according to the first aspect of the invention, may be used with other apparatuses that may be configured for being fixed to the end of the handlebar 900, mutatis mutandis, and/or may be used as a stand-alone storage unit that may be accommodated, for example, in a pocket or elsewhere.

The storage unit 700′ is thus also configured for being selectively stowed in and retrieved from the internal cavity 901, in particular the primary cavity 905, of the bicycle handlebar 900 via the open end 976 of the handlebar 900. The storage unit 700′ comprises an elongate housing 710′ having a proximal end wall 720′ and a distal end wall 730′, and further defines an internal storage volume V″ therein. The storage unit 700′ is configured having an absence of engagement arrangement for fixedly engaging the storage unit to the inside surface, i.e. internal surface 907, of the primary cavity 905.

While in this embodiment the housing 710′ has a generally rectangular cross-section, in other variations of this embodiment the housing 710′ may instead have any other suitable cross-section, for example circular, elliptical, polygonal, corrugated, etc.

The distal end wall 730′ fishtails distally to a generally rounded end. Proximal end wall 720′ comprises a gripping portion 740′ at the end thereof, and at least a proximal part of the gripping portion 740′, is configured for projecting to an outside of the handlebar 900 when the housing 710′ is accommodated fully or partially within the internal cavity 901, in particular the primary cavity 905 (for example, a proximal part of the housing 710′ may be accommodated in the proximal casing portion 121P and possibly also in the internal cavity 164 of the end cap member 160).

The gripping portion 740′ is in the form of strip of material proximally projecting from the end wall 720′, for example. In alternative variations of this embodiment, the gripping portion 740′ may instead be in the form of a chord, string, chain, flexible tab, and so on.

Gripping portion 740′ comprises an upper face 741′ and a lower face 742′, each being dimensioned to be graspable by one or another of a finger and thumb of one hand to enable the cyclist to retrieve the storage unit 700′ with one hand even while cycling, while at the same time being sufficiently small to fit partially within the cavity 901, or at least primary cavity 905, when the storage unit 700′ is in the stowed position. In alternative variations of this embodiment, the proximal end of the gripping portion 740′ comprises a loop, ring, or the like dimensioned to enable one or another of a finger and thumb of one hand to be at least partially inserted therein to enable the cyclist to retrieve the storage unit 700′ with one hand even while cycling, while at the same time the engagement portion 721′ (which is intermediate the gripping portion and the housing) being sufficiently small to fit partially within the cavity 901, or at least primary cavity 905, when the storage unit is in the stowed position.

In this embodiment, the storage unit 700′ is configured as a reusable storage unit, and in particular is further configured for selectively opening and closing access to its internal volume V″. Such access is provided via a longitudinal opening, which may be opened or closed via a closure arrangement, which in this embodiment is in the form of a zipper 750′ having a slider 755′ that slides longitudinally over the zipper teeth from a distal end to a proximal end thereof to close the zipper and thus said longitudinal opening, and slides back towards the distal end of the zipper to open the longitudinal opening. The storage unit 700′ further optionally comprises a pulling chord 760′ attached to the slider 755′.

In alternative variations of this embodiment, the storage unit 700′, in particular the housing 710′, comprises different closure means, for example studs, Velcro, buttons, etc., and/or the opening is not necessarily longitudinal. For example, the opening may comprise a partial or full circumferential opening, or any other suitable configuration.

In this embodiment, the storage unit 700′ may be formed in several parts suitably joined together. In alternative variations of this embodiment, the storage unit may instead be formed as an integral unit, and thus the housing 710′, distal end wall 730′ and said proximal end wall 720′ are integrally formed, together with the gripping portion 740′, and the zipper 750′ is subsequently attached to the housing 710′.

By way of non-limiting example, length L′ of the storage unit 700′ may be about 220 mm and width W′ can be about 60 mm.

In this embodiment, the internal storage volume is configured for water-proof storing of products, and the internal storage volume V″ can be lined with a water-proof lining. In alternative variations of this embodiment, the storage unit 700′, in particular the housing 710′, is made from a water-proof material.

According to this embodiment, the internal storage volume V″ comprises one or more retrievable items, for example documents, money, or even consumable products, for example an energy product configured for enhancing athletic performance of the human body, wherein the consumable is wrapped in as suitable wrapper.

As with the first embodiment of the storage item, in the second embodiment the storage item 700′ is particularly configured for being selectively engaged and disengaged with respect to the apparatus 100, in particular for being selectively clamped and unclamped with respect to one or another of the two clamps 350 of the apparatus 100. Thus, in order to engage the storage unit 700′ with the apparatus 100 in the stowed position, the end cap 160 is opened, as disclosed above, and the storage unit 700′ is inserted into the primary cavity 905 such that a proximal part of the gripping portion 740′ projects proximally from the open proximal casing end 122. The proximal part of the engagement portion 721′ is the folded over the proximal edge 355 of one recess 354, so that proximal part of the gripping portion 740′ is now pointing in a general distal direction and is in general overlying relationship with or at least in facing relationship with, an external surface of the ring member 120, i.e., an outside of the apparatus. Thereafter, the end cap 160 may be closed, and the respective clamping tab 352 automatically clamps the engagement portion 721′ onto the clamp recess 354.

While such stowage of the storage unit 700′ may be accomplished with one hand and while on the go, it is envisaged that the cyclist will normally stow the storage unit 700′ in the handlebar 900 prior to commencing cycling or whenever else the bicycle is at rest.

Retrieval and use of the storage unit 700′ may be accomplished by the cyclist using one hand, and also while cycling, for example as follows. First, the end cap 160 is opened with one hand, as already disclosed above, and thus unclamps the engagement portion 721′. The gripping portion 740′ is grasped by one hand, typically via a finger and thumb of the cyclist's hand, and the storage unit 700′ may be pulled out by the cyclist while still grasping the gripping portion 740′. The storage unit 700′ can be manipulated so that the hand (the same hand, or alternatively the storage unit 700′ can be transferred to the other hand instead) is now holding the housing 710′, and the slider 755′ (or the free end of chord 760′) may now be gripped by the teeth of the cyclist, for example, and a longitudinal force induced between the slider 755′ and the remainder of the storage unit 700′, by pulling the storage unit 700′ away so that the zipper 750′ slides distally to open from the storage unit 700.

The internal volume V″ is now in communication with the outside of the storage unit 700″, and allows the user to take out any of the contents thereof, for example via the mouth or the other hand.

Once the storage unit 700′ is removed, the end cap 160 may be closed again if desired.

It is readily understood that the storage unit 700′ may be clamped to one or the other of the two clamps 350.

It is also readily understood that, depending on the specific dimensions of the storage unit 700′, more than one storage unit 700′ (and/or a combination of one or more storage units 700 and one or more storage units 700′) may be accommodated in the internal cavity 901, in particular the primary cavity 905, and that one or more such storage units 700′ (and/or storage unit 700) may be clamped by each one of the two clamps 350, for example in juxtaposed or overlying relationship. In such cases, the user may choose to retrieve all the storage units at the same time, or to retrieve one storage unit at a time, inbetween closing the apparatus 100 via end cap member 160 while mainlining clamped the remaining storage units with respect to the apparatus 100.

It is readily understood that the disclosed embodiment of the storage unit 700, or alternative variations thereof, of the storage unit 700′, or alternative variations thereof, may also be used with different systems associated with the handlebars.

Conversely, the disclosed embodiment for apparatus 100 can also be used in conjunction with different types of items or storage units. For example, a storage unit dimensioned to fit within the internal cavity 901, in particular the primary cavity 905, and such a storage unit can comprise a string that is clamped by the clamp 350 and is further used for retrieving the a storage unit when the end cap 160 is opened and the string is unclamped.

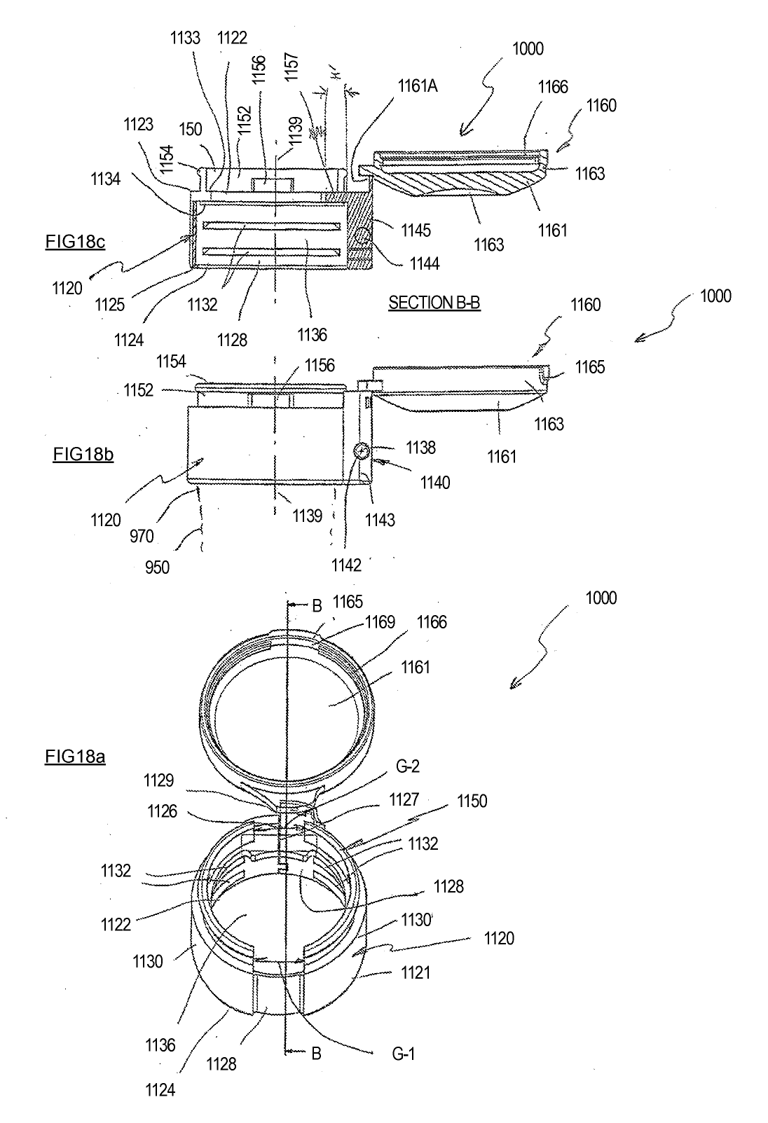

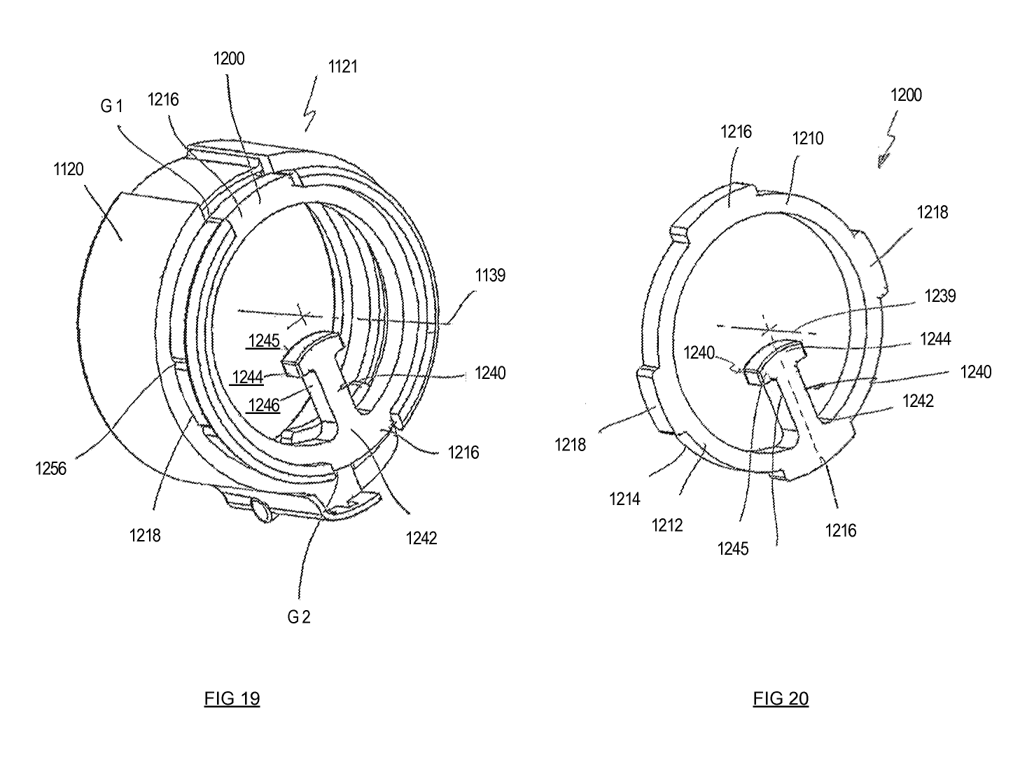

Also according to the first aspect of the invention, and referring to FIGS. 18(a) to 18(c), an apparatus (also referred to interchangeably herein as an accessory) for a bicycle handlebar according to a second embodiment of the invention, generally designated 1000, is configured for being fixedly secured to the aforementioned handlebar 900 of a bicycle 10, as has already been disclosed for the first embodiment and with reference to FIGS. 1 and 2, mutatis mutandis.

As in the first embodiment, mutatis mutandis, while one apparatus 1000 may be fixedly to the end 970 of one handgrip 950, it will be appreciated that the handlebar 900 may optionally have two such apparatuses 1000 fixedly attached thereto, one said apparatus 1000 at each of the two ends 970 of the handlebar.

The apparatus 1000 comprises a ring member 1120 configured for selectively enabling access to the handlebar cavity 901, in particular the primary cavity 905, via said ring member 1120, wherein the apparatus 1000 is configured in use for facilitating at least retrieval of one or more items (also referred to interchangeably herein as articles) previously accommodated in the handlebar cavity 901, in particular the primary cavity 905, via said ring member 1120 with one hand at least while the bicycle is in motion, and wherein said ring member 1120 is configured for remaining fixedly secured to the external surface 972 at least during such retrieval.

Referring in particular to FIG. 18(a) to FIG. 18(c), ring member 1120 comprises a generally tubular casing 1121 having a proximal, generally annular, open casing end 1122, a distal, generally annular, open casing end 1124, and a longitudinal axis 1139. A proximal annular edge 1123 circumscribes the proximal end 1122, and a distal annular edge 1125 circumscribes the distal end 1124. A longitudinal passageway or passage 1136 is thus provided between the proximal casing end 1122 and the distal casing end 1124.

Referring in particular to FIG. 18(a), the casing 1121 is formed with a generally longitudinal slit arrangement 1129 extending between the two edges 1123, 1125 to define opposed longitudinal casing edges 1126, 1127. The casing 1121 further comprises a longitudinal flexible section 1128, diametrically opposite the slit arrangement 1129. Thus, the casing 1121 comprises two generally C-shaped casing halves 1130 longitudinally joined to one another via the flexible section 1128, which allows the two halves 1130 to be reversibly pulled away from one another by flexing about an axis parallel to the longitudinal axis 1139. For example, flexible section 1128 may comprise a film hinge.

A locking arrangement 1140 is provided for locking the longitudinal casing edges 1126, 1127 in mutual abutment, thereby closing the slit arrangement 1129. In this embodiment, the locking arrangement 1140 comprises a locking screw 1142, rotatably mounted about a transverse axis 1138 to one casing half 1130 on flange 1143, and engageable with an internally threaded well 1144 provided in the other casing half 1130 on opposed flange 1145. Thus, as the locking screw 1142 is turned in one direction when engaged in the well 1144 the two longitudinal casing edges 1126, 1127 are locked together. Conversely, as the locking screw 1142 is turned in the other direction, the longitudinal casing edges 1126, 1127 are separated, effectively increasing the internal diameter of the casing 1121 and thus also increasing the size of the cross-section of passage 1136.

The casing 1121 comprises an inner generally cylindrical surface 1128 that is configured for being securely fixed onto the external surface 972. In particular, each casing half 1130 has two semi-annular rims 1132 inwardly projecting from the respective portions of the inner surface 1128. Each rim 1132 has a cross-section that narrows from a relatively wide base at the inner surface 1128 to an apex 1131 distanced therefrom. The rims 1132 are resilient, or at least deformable, when a radial force is applied thereto.

The casing 1121 further comprises a longitudinal stop 1137 that radially projects from inner surface 1128 towards the longitudinal axis 1139 to a height H′, as best seen in FIG. 18(c). In some alternative variations of this embodiment, longitudinal stop 1137 may be omitted.

To fixedly secure the apparatus 1000 onto the respective end 970 of the handlebar 900, the locking arrangement 1140 is unlocked and the two casing halves 1130 separated, by flexing about the longitudinal flexible section 1128, to increase the effective internal diameter of the casing 1121 to a diameter much greater than the external diameter of the end 970. The open casing 1121 is then placed in longitudinal overlying relationship with the respective end 970, until the longitudinal stop 1137, or at least the distal-facing annular shoulder 1134 that projects inwardly from inner surface 1128, is in abutment with the respective edge 975. Thereafter the two casing halves 1130 are brought together so that the longitudinal casing edges 1126, 1127 are brought into mutual abutment and locked in place. Concurrently, the inner surface 1128 is brought closer to outer surface 972, and rims 1132 are deformably and/or resiliently abutted onto the surface 972 to form a pressure and/or friction fit therewith, thereby fixedly securing the ring member 1120 onto the end 970.

When the apparatus 1000 is fixedly secured to the handlebar 900, the ring member 1120 provides access to the respective primary cavity 905 via open casing end 1122, and furthermore provides protection from the relatively sharp edge 975, which often is a relatively sharp edge.

The open casing end 1122 comprises a proximally projecting structure 1150 that has one or more purposes.

Referring in particular to FIGS. 18(b) and 18(c), structure 1150 comprises, on each casing half 1130, a respective C-shaped wall 1152, longitudinally projecting proximally from the open end 1122, and having an enlarged lip portion 1154 at the proximal end thereof. Each wall 1152 comprises a lateral opening 1156 therethrough, the purpose of which will become clearer below. When the apparatus 1000 is fixedly secured to the handlebar 900, the lateral free ends of one C-shaped wall 1152 are laterally separated from the respective lateral free ends of the other C-shaped wall 1152 via lateral gaps G1 and G2, as illustrated in FIG. 18(a), for example.

Furthermore, and referring in particular to FIG. 18(c), it is to be noted that the open end 1122 comprises, in addition to the a distal-facing annular shoulder 1134 that projects inwardly from inner surface 1128 and is configured for abutting onto edge 975 of the handlebar. It is also to be noted that the open end 1122 comprises a proximal-facing annular shoulder 1133 that projects inwardly from the C-shaped walls 1152.

The apparatus 1000 further comprises an end cap member 1160, which in this embodiment is hingedly connected to the ring member 1120 via hinge 1161A, which may be, for example, a film hinge, or any other suitable hinge. End cap member 1160 comprises an end wall 1161 configured for substantially covering the open casing end 1122, and a peripheral wall 1163 depending from the end wall 1161 and which is configured for locking onto structure 1150, when the end cap member 1160 is in the closed position with respect to the ring member 1120. Referring in particular to FIGS. 18(a) and 18(c), the peripheral wall 1163 comprises a partial annular rim 1166 that is configured for engaging with respect to the enlarged portion 1154 of structure 1150 to provide a “click fit” closure for the end cap member 1160 with respect to the ring member 1120. A tab 1165 on the peripheral wall 1163 facilitates “unclicking” the closure and opening the end cap member 1160 with respect to the ring member 1120 with one finger of one hand of the cyclist, typically the thumb. The outer surface of the end wall 1161 has an indentation 1168 shaped to accommodate the tip of a finger, typically a thumb, so that the end cap member 1160 may be clicked to the closed position with the finger (typically thumb) of one hand of the cyclist.

It is to be noted that by being fixedly secured to the outer surface 972 of the handlebar end 970, the open casing end 1122 allows open communication with substantially the full transverse cross-section of the handlebar cavity 901, in particular substantially the full transverse cross-section of primary cavity 905. An item having an external diameter up to just under the internal diameter of the primary cavity 905 and having a proximal finger-gripping portion may be stored in the primary cavity 905 for later retrieval by the cyclist, while ring member 1120 remains fixedly secured to the handlebar 900, and thus does not require dismantling of the apparatus 1000 or part thereof in order to access the stored item.

Thus, in operation of this embodiment, such an item may be stored within the primary cavity 905, such that the finger-gripping portion of the item is projecting proximally of proximal annular edge 1123. Optionally, a permanent or semi-permanent distal stop (not shown) may be provided within the primary cavity 905, unconnected to the apparatus 1000, to prevent the item from being introduced further into the primary cavity 905. The end cap member 1160 may be closed, thereby preventing the item from falling out of the primary cavity 905. When the cyclist wishes to retrieve the item, the cyclist can click open the end cap member 1160 using a finger or thumb to press the tab 1165 in a generally proximal direction, thereby exposing the finger gripping portion of the item, which the cyclist can grasp with a finger and thumb of the same hand that was used for opening the apparatus 1000.

Thus, retrieval of the stored item from the primary cavity 905 may be achieved by one hand of the cyclist even when the bicycle is in motion, since cyclist are routinely capable of controlling a bicycle with only one hand (the other hand in this case), even when cycling at great speed. Furthermore, since during such retrieval the cyclist's hand remains close to the respective handlebar end 972, it enables the cyclist to regain control of the bicycle with this hand almost instantaneously, should he need to, and moreover there is no significant danger of this hand colliding with an adjacent cyclist, pedestrian or other structure, and thus enables the cyclist to retrieve the item even when there are other cyclists in close proximity.

The structure of the apparatus also allows the cyclist to close the primary cavity 905 by clicking closed the end cap member 1160 onto the ring member 1120, by first manipulating the end cap member 1160 into alignment with the ring member 1120 with one hand, and then pushing the end cap member 1160 to click close with a finger or thumb. Thus, closure of the apparatus can also be performed by the cyclist with one hand and when on the go.

It is to be noted that in alternative variations of this embodiment, the end cap member 1160 may be omitted, and the ring member 1120 remains open. In such cases the stored item may be held in the stowed position inside the primary cavity 905 until it is retrieved, in a number of ways. For example, the body of the item may be in frictional contact with the internal surface 907, though not fixedly secured thereto. The frictional contact prevents the item from sliding out, but may be overcome by the pulling force provided by the cyclist when the cyclist wishes to retrieve the item. On the other hand the ring member 1120 prevents injury to the cyclist from edge 975 when retrieving the item. Thus, no mechanical arrangement or other mechanism is required to keep the item in place or for releasing it to the cyclist, which can retrieve it with one hand, and while on the go.

In the second embodiment and in at least some alternative variations thereof, the apparatus 1000 is configured for being fixedly secured to a handlebar having a conventional inner diameter of 20.5 mm, and is thus retrofittable onto many existing conventional handlebars and/or may be factory-fitted onto new bicycles having handlebars of such conventional inner diameter.

In at least some other alternative variations of this embodiment, though, the handlebar may be manufactured in a size greater than the aforementioned conventional size, for example having the internal diameter larger than the conventional 20.5 mm diameter. For example, such an increased internal diameter may be up to 5%, 10%, 15%, 20%, 25%, 30%, 35%, 40%, 45%, 50%, 60%, 70%, 80%, 90%, 100% larger, or larger, providing respective internal diameters of 21.525 mm, 22.55 mm, 23.575 mm or 24.6 mm, 25.625 mm, 26.65 mm, 27.675 mm, 28.7 mm, 29.725 mm, 30.75 mm, 32.8 mm, 34.85 mm, 36.9 mm, 38.95 mm, 41 mm, or greater, respectively. In these or other alternative variations of this embodiment, though, the handlebar may be manufactured with, or may be modified to have, an external screw thread, bayonet fit, or other engagement means on the external surface 972, that is complementary to an internal thread, bayonet mount or other complementary engagement means provided on the ring member 1120, enabling the ring member to be fixedly secured to the external surface 972 of the end 970 by simple hand manipulations, optionally without the need for tools; in such cases the ring member 1120 may omit the locking arrangement 1140.

In a third embodiment of the invention, and referring to FIGS. 19 and 20, the apparatus 1000, as disclosed for the second embodiment and alternative variations thereof, mutatis mutandis, is configured for being selectively engaged with at least one storage unit at least when the storage unit is in a stowed position accommodated within the internal cavity 901, in particular the primary cavity 905, in use of said apparatus 1000. In particular, in the third embodiment the apparatus 1000 is further configured for enabling selectively disengaging at least one item from the apparatus to facilitate retrieval of the item from the primary cavity 905 in use of the apparatus.

In the third embodiment, the apparatus 1000 further comprises a ring-shaped carrier, also referred to herein as ring element 1200, that is engaged with or fixedly secured to the ring member 1120 at least during use. Ring element 1200 comprises an annular ring portion 1210 having a flat proximal annular face 1212 and a flat distal annular face 1214. The ring portion 1210 further comprises a first pair of lateral tabs 1216 projecting laterally in diametrically opposite directions, and are configured for being accommodated in gaps G1, G2 respectively when the ring element 1200 is engaged with the ring member 1120. Further, ring portion 1210 also comprises a second pair of lateral tabs 1218 projecting laterally in diametrically opposite directions, but different from the projection directions of the first pair of lateral tabs 1216, and are configured for being accommodated in the respective lateral openings 1156 when the ring element 1200 is engaged with the ring member 1120. When the ring element 1200 is thus engaged with the ring member 1120, the distal face 1214 is in abutment with shoulder 1133 (see also FIG. 18(c)).

The ring element 1200 further comprises a strut member 1240 comprising a strut base 1242 and a free end 1244, the strut member being inwardly cantilevered from a periphery of the ring element 1210, which in use of the apparatus is distal of the open end 1122 and of the end 970 of the handlebar. The strut member 1240 is configured for reversibly engaging with a distal end of the item being selectively stored and retrieved from the primary cavity 905, which in turn is configured for reversibly engaging with the strut member 1240. The strut member 1240 radially projects from the strut base 1242 towards a longitudinal centerline of said ring member 1200, i.e., the longitudinal axis 1139, though in this embodiment the free end 1244 does not reach the longitudinal axis 1139.

The free end 1244 comprises an enlarged portion 1245, and further comprises a narrower neck portion 1246 intermediate the enlarged portion 1245 and the strut base 1242.

While in this embodiment the strut member 1240 is integrally formed on the ring element 1200, in alternative variations of this embodiment the strut member 1240 may be suitably joined to the ring element 1200.

In yet other alternative variations of this embodiment, the strut member may be formed integrally with or is joined directly to the ring member 1120, without the need for the ring element 1210 which can then be omitted. In such embodiments, the strut member is inwardly cantilevered from a periphery of an outer-facing annular edge of the ring member 1120, which in use of the apparatus 1000 is distal of the open end of the handlebar.

In yet other alternative variations of this embodiment, the ring element 1200 may be formed integrally with or is joined directly to the ring member 1120, but without the need for tabs 1216 and tabs 1218, which can then be omitted—for example the ring element 1200 may be bonded or welded to the ring member 1120.

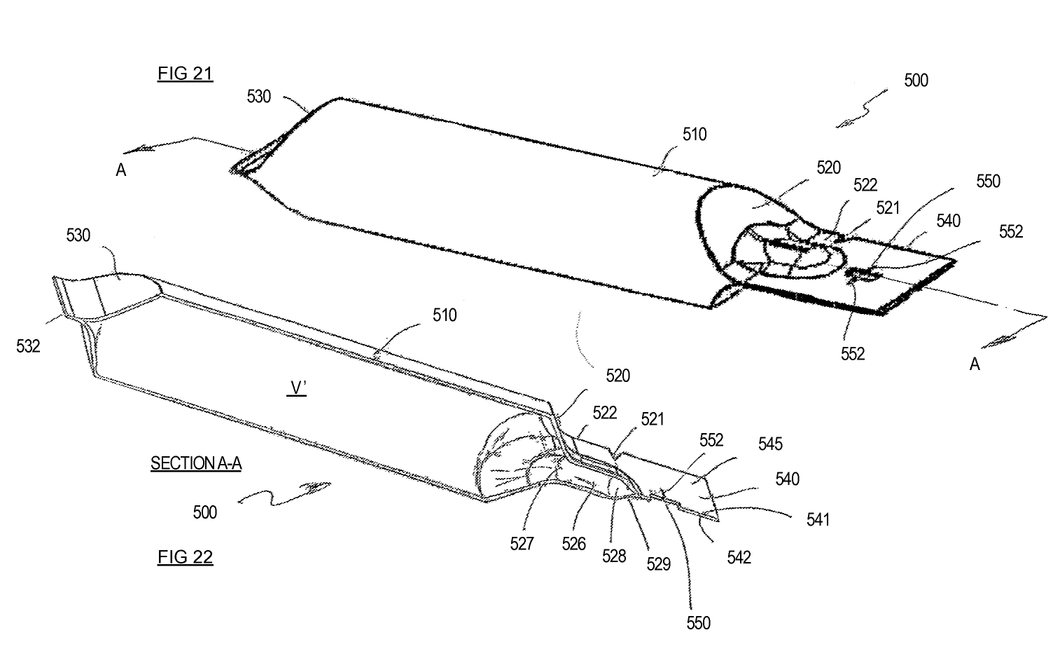

Referring to FIGS. 21 and 22, a second embodiment of an item in the form of a storage unit according to the second aspect of the invention, and designated with the reference numeral 500, is per se novel and is particularly configured for use with the apparatus according to the third embodiment of the invention or alternative variations thereof.

The storage unit 500 is configured for being selectively stowed in and retrieved from the internal cavity 901, in particular the primary cavity 905, of the bicycle handlebar 900 via the open end 976 of the handlebar 900 that, as has already been discussed, is in open communication with the internal cavity 901, in particular primary cavity 905. The storage unit 500 comprises an elongate, generally tubular housing 510 having a proximal end wall 520 and a distal end wall 530, and further defines an internal storage volume V′. The storage unit 500 is configured having an absence of engagement arrangement for fixedly engaging the storage unit to the inside surface, i.e. internal surface 907, of the primary cavity 905.

The distal end wall 530 fishtails distally to a distal tab 532 that is centrally disposed with respect to the distal end wall 530. Similarly, proximal end wall 520 fishtails proximally to a proximal tab 522 that is also centrally disposed with respect to the proximal end wall 520.

The proximal end wall 520 has a finger grip portion 540, configured for being accommodated fully or partially within the internal cavity 901, in particular the primary cavity 905, when the storage unit 500 is stowed therein. The finger grip portion 540 is in the form of an extended tab portion 545 contiguous with and proximally projecting from the proximal tab 522. The proximal end wall 520 further comprises an access tube 526 having a distal end 527 in open communication with the internal storage volume V′ and a proximal end 528 that is closed via a removable cap 529, which in this embodiment is tearable therefrom responsive to the application of a suitable shear force. The proximal tab 522 extends proximally the longitudinal length of the tube 526 and is integrally formed therewith. The storage unit comprises a weakened structure in the vicinity of the internal storage volume V′, in the form of a lateral notch 521. The cap 529 is at the distal end of extended tab portion 545 and is integrally formed therewith, and lateral notch 521 is provided between proximal tab 522 and extended tab portion 545. While the proximal tab 522, extended tab portion 545, access tube 526 and cap 529 are formed as an integral unit, the notch 521 enables the extended tab portion 545 together with cap 529 to be easily torn away from the proximal tab 522 and access tube 526 when a shearing force is applied thereat. The storage unit 500 is constructed so that such a shearing force may be generated, for example, by holding the housing 510 with one hand, and the extended tab portion 545 with the other hand or the teeth, and pulling the housing 510 away from the extended tab portion 545. In particular, the materials from which the storage unit 500 is constructed, and the particular geometry of the notch 521 may be chosen to ensure that an average shearing force generated in this manner is sufficient to tear off the extended tab portion 545 together with cap 529 away from the proximal tab 522 and access tube 526.

In alternative variations of this embodiment, a weakened structure, wherein the storage unit comprises a weakened structure in the vicinity of said internal storage volume, for example a weakened or perforated line, may be provided between the proximal tab 522 and the extended tab portion 545 instead of or in addition to notch 521.

Finger grip portion or extended tab portion 545 comprises an upper face 541 and a lower face 542, each on the one hand being sufficiently large to be grasped by a finger and thumb of one hand to enable the cyclist to retrieve the storage unit 500 with one hand even while cycling, while on the other hand being sufficiently small to fit partially or fully within the cavity 901, or at least primary cavity 905, when the storage unit is in the stowed position.

The storage unit 500 is configured for being selectively engaged and disengaged with respect to strut member 1240 of the apparatus 1000. In the illustrated embodiment storage unit 500 comprises an opening 550 formed in the extended tab portion 545 that is selectively releasably engageable with respect to the free end 1244 of strut member 1240. In particular, the opening 550 is nominally smaller than the cross-section of the enlarged portion 1245, and is reversibly deformable to allow the extended tab portion 545 to be forced over the enlarged portion 1245 and subsequently engaged at neck portion 1246. A periphery of the opening 550 is deformable to allow reversible expansion of said opening. In particular, there are two pre-formed cuts 552, one on each lateral side of the opening 550, which thereby attains a cruciform shape, and the tab material in the vicinity of the cuts 552 reversibly deform when the extended tab portion 545 is forced over the enlarged portion 1245.

In this embodiment, at least the proximal tab 522 and extended tab portion 545 are resilient, and have a datum unstressed position generally aligned with the longitudinal axis 1139, when the storage unit 500 is inserted in the primary cavity 905 such that the opening 550 is in overlying relationship with the strut member 1240. Thus, in this unstressed position, the extended tab portion 545 is above the enlarged member 1245 and not in any engaging contact therewith.

Thus, in order to engage the storage unit 500 with the apparatus 1000 in the stowed position, the storage unit 500 is first inserted in the primary cavity 905 such that the opening 550 is in overlying relationship with the strut member 1240, and thereafter the extended tab portion 545 is forced over the enlarged portion 1245 and is subsequently engaged at neck portion 1246. Thereafter, the end cap 1160 may be closed. While such stowage of the storage unit 500 may be accomplished with one hand and while on the go, it is envisaged that the cyclist will stow the storage unit 500 in the handlebar 900 prior to commencing cycling or whenever else the bicycle is at rest.

In this embodiment, the storage unit 500 is formed as an integral unit, and thus the housing 510, distal end wall 530 and said proximal end wall 520 are integrally formed, together with the proximal tab 522, extended tab portion 545, access tube 526 and cap 529. In alternative variations of this embodiment, the storage unit may instead be formed in several parts suitably joined together.

In this embodiment, the internal storage volume is configured for storing consumable products, and the internal storage volume V′ is lined with a lining configured for conserving consumable products that may be stored therein. In alternative variations of this embodiment, the storage unit 500, in particular the housing 510, is made from a material configured for conserving consumable products that may be stored in the internal storage volume.

In at least this embodiment, the storage unit 500 is made from disposable materials and is disposed of after use.

According to the third embodiment, the internal storage volume V′ comprises a consumable product, for example an energy product configured for enhancing athletic performance of the human body. In this embodiment, the housing 510 is formed as an elongate generally cylindrical reservoir, for storing a liquid or gel, and the consumable product is in the form of a drink or gel, respectively. Many examples of such drinks and gels are known in the art and are generally suitable for being stored in the storage unit 500.

In alternative variations of this embodiment, the housing 510 may be configured for storing non-flowable matter, such as solids, and such consumable products may be HI in the form of “chewables”, “sports bars” and so on as known in the art. In such embodiments, the storage unit does not require the access tube 526, but is otherwise used in a similar manner to that disclosed herein, mutatis mutandis, so that when the extended tab portion 545 is ripped off, it fully opens up the internal storage volume, and enables the solid consumable to be removed from the package.

Furthermore, in this embodiment, the storage unit 500, and in particular the housing 510, has an absence of a discrete closable opening to the internal storage volume or a closure therefor, and thus once opened remains open.

Retrieval and use of the storage unit 500 may be accomplished by the cyclist using one hand, and also while cycling, for example as follows. First, the end cap 1160 is opened with one hand, as already disclosed for the second embodiment mutatis mutandis. (It is to be noted, though, that in some alternative variations of the third embodiment the apparatus 1000 may omit the end cap 1160, and thus cap opening and cap closing steps are not required.) Then, the extended tab portion 545 is grasped by one hand, typically via a finger and thumb of the cyclist's hand, and the extended tab portion 545 is forced back by the cyclist over the enlarged portion 1245 and away at neck portion 1246, thereby disengaging the storage unit 500 from the strut element 1240. The natural resilience of the proximal tab 522 and extended tab portion 545 returns the extended tab portion 545 to the datum unstressed position aligned with the longitudinal axis 1139 and thus above the strut element 1240. At this point, the storage unit 500 may be pulled out by the cyclist while still grasping the extended tab portion 545, and manipulated so that the hand is now holding the housing 510, and the extended tab portion 545 is free. The extended tab portion 545 may now be gripped by the teeth of the cyclist, for example, and a shearing force induced between the extended tab portion 545 and the remainder of the storage unit 500, by pulling the storage unit 500 away so that the extended tab portion 545 is ripped off or torn away from the proximal tab 522 due to the concentration of stress at the notch 521, also removing the cap 529 from tube 526. Thus, the storage unit 500 is configured for enabling access to the internal storage volume V′ responsive to a destructive action carried out on the storage unit.

The internal volume V′ is now in fluid communication with the outside of the storage unit 500, and allows the user to suck out any fluid or gel contents thereof via oral suction applied to the opening 528, or to squeeze such fluid or gel contents out by squeezing the housing 510.

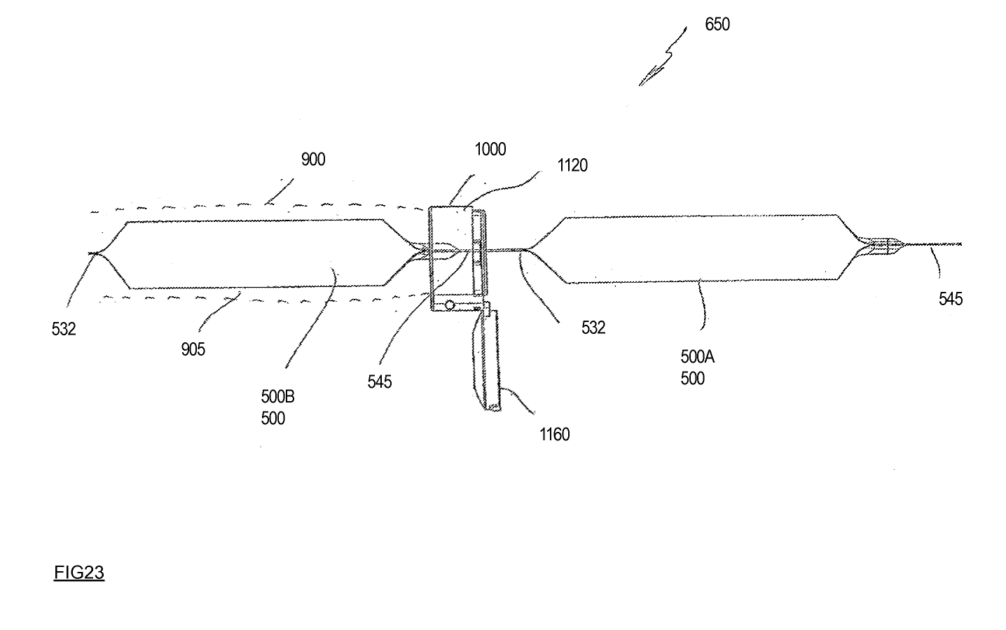

In a third embodiment of the stored item or storage unit according to the invention, and referring to FIG. 23, the storage unit 500, as disclosed for the second embodiment and alternative variations thereof, mutatis mutandis, is further configured for being temporarily connected with a second such storage unit 500. Thus in the third embodiment a storage unit chain 600 is provided, comprising two (or more) storage units 500 serially joined so that the distal tab 532 of the proximal storage unit 500 (also marked in FIG. 23 as “500A”) is connected to the extended tab portion 545 of the distal storage unit 500 (also marked in FIG. 23 as “500B”) by a weakened structure such as a series of perforations or notches, for example.

In order to engage the storage unit chain 600 with the apparatus 1000, the two joined storage units 500A, 500B are first inserted in the primary cavity 905 such that the opening 550 of the proximal storage unit 500A is in overlying relationship with the strut member 1240, and thereafter the extended tab portion 545 is forced over the enlarged portion 1245 and is subsequently engaged at neck portion 1246. Thereafter, the end cap 1160 may be closed. While such stowage of the storage unit 500 may be accomplished with one hand and while on the go, it is envisaged that the cyclist will stow the storage unit 500 in the handlebar 900 prior to commencing cycling.

Retrieval and use of each of the storage units 500A, 500A is similar to that disclosed above for a single storage unit 500 with one main difference, mutatis mutandis, and may be accomplished by the cyclist using one hand, and also while cycling. First, the proximal storage unit 500A is retrieved in a similar manner to that disclosed above for a single storage unit 500, mutatis mutandis, but prior to removing and opening the proximal storage unit 500A, the distal storage unit 500B is engaged to the apparatus 1000 for later retrieval. This may be done as follows, for example. Referring to FIG. 23, when the proximal storage unit 500A is fully extracted from the primary cavity 905 and the cyclist maneuvers the storage unit chain 600 with the hand that is holding the proximal storage unit 500A so that the extended tab portion 545 of the distal storage unit 500B is now in overlying relationship with the strut member 1240, and thereafter this extended tab portion 545 is forced over the enlarged portion 1245 and is subsequently engaged at neck portion 1246 by further manipulations of the proximal storage unit 500A. Thereafter, a shearing force may be applied between the proximal storage unit 500A being held with one hand, and the distal storage unit 500B that is now engaged by the apparatus 1000, and this results in the distal tab 532 of the proximal storage unit 500A tearing or ripping away from the extended tab portion 545 of the distal storage unit 500B at perforations 590.

Thereafter, the end cap 1160 may be closed. The thus retrieved proximal storage unit 500A may then be opened with one hand and on the go, as disclosed above for the single storage unit 500, mutatis mutandis. The distal storage item 500B may be retrieved and opened whenever desired, by one hand and on the go, as disclosed above for the single storage unit 500, mutatis mutandis.

While such stowage of the storage unit chain 600 may be accomplished with one hand and while on the go, it is envisaged that the cyclist will stow the storage unit 500 in the handlebar 900 prior to commencing cycling.

In alternative variations of this embodiment, the storage unit chain 600 may comprise more than two storage units 500 serially joined to each other, one after the other and serially retrieved one at a time, in a similar manner to that disclosed for the embodiment illustrated in FIG. 23, mutatis mutandis.

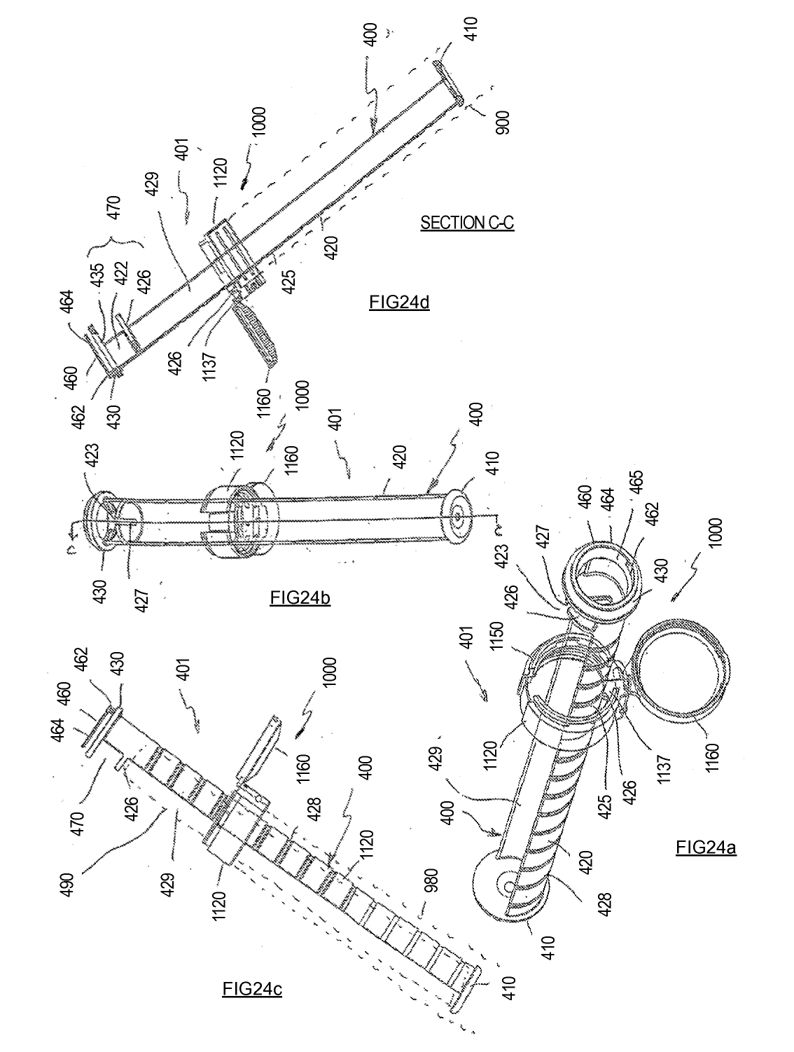

In a fourth embodiment according to the first aspect of the invention, and referring to FIGS. 24(a) to 24(d), the apparatus 1000, as disclosed for the second embodiment and alternative variations thereof of the first aspect of the invention, mutatis mutandis, is further configured for being selectively engaged with at least one storage unit 401 at least when the storage unit is in a stowed position accommodated within the internal cavity 901, in particular the primary cavity 905, in use of said apparatus 1000. In particular, in the fourth embodiment, the apparatus 1000, in particular the ring member 1120, is further configured for being selectively engaged with the storage unit 401 when the storage unit is in a (partially or fully) deployed position at least partially outside of the internal cavity in use of said apparatus.

In the fourth embodiment, the storage unit 401 is selectively slidingly displaceable between the stowed position and the deployed position, and the storage unit 401 is configured for allowing at least retrieval of at least one stored item therefrom when the storage unit is in the deployed position.

In the fourth embodiment, the storage unit 401 is in the form of a storage tray 400 that is movably mounted to the ring member 1120. The storage tray 400 is selectively slidingly movable with respect to the ring member 1120 between a stowed position and a deployed position. The tray 400 is configured for enabling items 490 (FIG. 24(c)) to be accommodated therein when the tray 400 is in the stowed position, and for enabling such items 490 to be retrieved from the tray 400 when said tray 400 is in the deployed position.

The storage tray 400 comprises an elongate trough member 420, a distal tray end wall 410 and an annular proximal tray end wall 430 at opposite longitudinal ends of the trough member 420. The trough member 420 is in the form of a half cylinder having a diameter smaller than the inner diameter of the primary cavity 905. Thus, the trough member 420 has a generally semi-circular transverse cross-section along a longitudinal length of the trough member 420.

The distal tray end wall 410 is in the form of a disc having a diameter smaller than the inner diameter of the primary cavity 905, though larger than that of the trough member 420. The proximal tray end wall 430 is in the form of a ring defining a central opening 435, and having an outer diameter smaller than the inner diameter of the projecting structure 1150 and larger than that of the trough member 420.

Thus, the trough member is configured for being slidingly displaced with respect to passageway 1136 between the stowed position and the deployed position. Referring in particular to FIGS. 18(c), 24(a) and 24(d), the outer cylindrical surface 425 of the trough member 420 rests on and is in sliding contact with the inward facing curved contact surface 426 of stop 1137, which effectively acts as a sliding support. Thus, in this embodiment, the trough member 420 has an external diameter generally complementary to the internal diameter of said cylindrical passageway defined at the contact surface 426 of stop 1137.

In the stowed position, the proximal end wall 430 is in abutment with shoulder 1122 and a proximal face of stop 1137. In the deployed position, the distal end wall 410 is in abutment with a distal face of stop 1137, and the tray is thus prevented from disengaging from the ring member 1120 and thus from exiting the handlebar 900, when the apparatus is fixedly attached thereto.

The tray 400 may be assembled with the ring member 1120 by first opening the ring member 1120 and separating the longitudinal casing edges 1126, 1127 sufficiently so that the effective internal diameter of the passageway 1136 exceeds the diameter of the distal wall 410, enabling the tray 400 to be inserted into the passageway 1136. Thereafter, the ring member 1120 may be closed. Alternatively, the tray 400 may be constructed such that one or another or both end walls 410, 430 are connectable to the trough member 420, and the tray is assembled by connecting the respective end wall 410 and/or 430 after the trough member 420 has been inserted through passageway 1136.

In this embodiment the trough member 420 is configured for being reversibly curved with respect to an elongate direction thereof, thus enabling the tray 400 to bend to conform to the curvature of the handlebar 900. In alternative variations of this embodiment, wherein the apparatus including the tray is to be used with straight handlebars, the tray is not required to bend.

In this embodiment, the trough member is made from a resilient material and is at least sufficiently resilient to enable the trough member 420 to be correspondingly curved when inserted into a part of the internal cavity 901 that is curved, for example the part of the primary cavity 905 corresponding to curved portion 960, and to enable the trough member 420 to be extracted from this part of the internal cavity to the deployed position. The trough member 420 is also formed with a plurality of longitudinally spaced corrugations 428 on the external surface 425, which are configured for further enabling said tray to reversibly bend within the primary cavity 905.

The tray 400 is configured for being deployed to the deployed position using one hand of the cyclist, and for this purpose comprises a handle member 460 that is pullable by the at least one finger of the cyclist. The handle member 460 is in the form of a ring member 464, proximally displaced away from a proximal face of the proximal end wall 430 by spacing member 462. Ring member 464 circumscribes a finger opening 465 that is sufficiently large to enable a finger of the cyclist of to be at least partially inserted therein to grasp the handle member sufficiently to enable pulling thereof. To further facilitate pulling of the tray, the proximal end of the tray 400 comprises a proximal recess 470 configured for enabling at least the tip of the finger of the cyclist to be introduced therein. Recess 470 includes central opening 435, a proximal portion 422 of the trough member 420 and partition 426. Thus, in operation the tip of one finger of the cyclist may be inserted into the recess 470 to thereby facilitate pulling the tray 400 to the deployed position.

The trough member 420 comprises a storage section 429 defined between the partition 426 and distal end wall 410. In this embodiment, the storage section 429 is particularly suited for accommodating therein a plurality of cylindrical items 490, each cylindrical item 490 having an external diameter generally complementary to the internal diameter of the trough member 420. For example, such items 490 may be monetary coins, sweets, gum, or other edible materials. Alternatively, the items are not required to be cylindrical, but can be accommodated in the storage section 429 if they occupy a volume and shape that may be accommodated in the storage section 429 when in the stowed position. For example, rolled up bank notes, papers or other small items may be stored in the tray 400.

Thus, in order to store items in the storage unit 401, apparatus 1000 including the storage unit 401 having been fixedly secured to the handlebar 900, the end cap 1160 is opened and the tray 400 is pulled proximally by a finger of the cyclist, for example. The items 490 are placed in the storage section 429 of the tray, and the tray 400 inserted into the primary cavity 905. Thereafter, the end cap 1160 may be closed.

While such stowage of the storage unit 401 may be accomplished with one hand and while on the go, it is envisaged that the cyclist will stow items in the storage unit 401 in the handlebar 900 prior to commencing cycling.

Retrieval and use of the storage unit 401 may be accomplished by the cyclist using one hand, and also while cycling, for example as follows. First, the end cap 1160 is opened with one hand, as already disclosed for the second embodiment of the apparatus, mutatis mutandis. Then, the cyclist inserts the tip of a finger into recess 470 and grasps the tray 400 with this finger tip and pulls the tray 400 proximally, either partially, for example as illustrated in FIGS. 24(a) to 24(d), or fully, sufficiently to expose an item 490 to an outside of the bicycle. The cyclist can remove the finger tip from recess 470 and using the same hand may now retrieve and take this item. Thereafter the cyclist may close the storage unit 401 by pushing the tray distally back to the stowed position, for example using one or more fingers or thumb of one hand. The end cap 1160 may then be closed as already disclosed for other embodiments, mutatis mutandis.

(It is to be noted, though, that in some alternative variations of the fourth embodiment the apparatus 1000 may omit the end cap 1160, and thus cap opening/closing step are not required.)

Referring to FIG. 24(a) and FIG. 24(b), for example, partition 426 comprises a diametric slot 427 having an open end 423 at the periphery of the partition 426 facing in a direction generally away from the trough member 420. This slot 423 may be used, for example, for inserting and anchoring one end of string to the partition, the other end of the string being outside of the end wall 430 and being configured for being grasped by the hand of the cyclist. For example, the graspable string end may comprise a loop or tab and may facilitate opening of the tray 400 by a cyclist, for example where the cyclist has large fingers and may have difficulty in otherwise grasping the handle 460 and/or in otherwise inserting the fingertip into recess 470.

In at least some alternative variations of the fourth embodiment, the storage unit 401 may be configured for covering the tray, in particular part or all of the storage section 429 of the tray 400, when in the stowed position and during movement of the tray 400 from the stowed position to the deployed position.

Tray 400 thus comprises a cover member (not shown) that is hingedly mounted to the trough member 420. For example, the cover member may be the form of a half cylinder having a diameter smaller than the inner diameter of the primary cavity 905. Thus, the cover member can have a generally semi-circular transverse cross-section along a longitudinal length of the cover member, generally corresponding to the semi-circular transverse cross-section of the trough member 420, so that when the cover member is in the closed position with respect to the trough member 420 the two together enclose a generally cylindrical storage volume. A longitudinal hinge arrangement (not shown) may be provided for enabling the cover member to reversibly pivot from a closed position, to an open position.

The cover member may be made from a resilient material and is at least sufficiently resilient to enable the cover member (together with the trough member 420) to be correspondingly curved when inserted into a part of the internal cavity 901 that is curved, for example the part of the primary cavity 905 corresponding to curved portion 960, and to enable the trough member 420 with the cover member to be extracted from this part of the internal cavity to the deployed position. The cover member may also be formed, optionally, with a plurality of longitudinally spaced corrugations on the external surface thereof, which are configured for further enabling the covered tray to reversibly bend within the primary cavity 905.

The cover member may extend distally from the partition 426 to a position PS. In this embodiment position PS is just proximal to the structure 1150 of the apparatus 1000 when the tray 400 is at the fully deployed position, so that the cover does not collide with the ring member 1120 when being opened at the fully deployed position. However, in other alternative variations of this embodiment the position PS may be much closer, proximally, to the partition 426, and thus the cover member may be opened as soon as this position is proximal to the structure 1150, when the tray is only partially deployed.

In order to store items in the covered storage unit 401, apparatus 1000 including the covered storage unit 401 having been fixedly secured to the handlebar 900, the end cap 1160 is opened and the tray 400 is pulled proximally by a finger of the cyclist, for example. The cover member may be opened by pivoting the same about the longitudinal hinge, and the items 490 are placed in the storage section 429 of the tray. The cover member is then closed over the trough member 420, and the tray 400 inserted into the primary cavity 905. Thereafter, the end cap 1160 may be closed.

Retrieval and use of the covered storage unit 401 may be accomplished by the cyclist using one hand, and also while cycling, for example as follows. First, the end cap 1160 is opened with one hand, and the tray 400 is pulled to the fully deployed position, or to a partially deployed position, as already disclosed for the fourth embodiment mutatis mutandis, such that position PS is proximal to the structure 1150. The cover member is then pivotably opened with the same hand that was used for pulling the tray 400 to expose an item 490 to an outside of the bicycle, and the cyclist can then retrieve and take this item with the same hand. Thereafter the cyclist may close the cover member and stow the covered storage unit 401 by pushing the tray distally back to the stowed position, for example using one or more fingers or thumb of one hand. The end cap 1160 may then be closed as already disclosed for other embodiments, mutatis mutandis. While the above embodiments have been described in the context of a drop handlebar, in which the open end 970 is generally distal of the transverse portion 910, they apply, mutatis mutandis, to drop handlebars in which the open end of the handlebar is generally proximal of the transverse portion, or indeed to any other type of handlebar, including straight handles bars, mutatis mutandis.

While the above embodiments for the apparatus and storage units have been described in the context of a drop handlebar, in which the open end 970 is generally distal of the transverse portion 910, they apply, mutatis mutandis, to drop handlebars in which the open end of the handlebar is generally proximal of the transverse portion, or indeed to any other type of handlebar, including straight handles bars, mutatis mutandis.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed example embodiments in accordance with the invention, it will be appreciated that many changes may be made therein without departing from the spirit of the invention.

1. Apparatus for a bicycle handlebar, the bicycle handlebar having an internal handlebar cavity in open communication with an open end of the handlebar, said open end having an edge and an external surface, the apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for at least enabling selective retrieval from the handlebar cavity of one or more items with one hand of a user at least while the bicycle is in motion, the one or more items being in a stowed position accommodated within said handlebar cavity, and wherein said ring member is configured for remaining fixedly secured to the external surface at least during said retrieval.

2. Apparatus according to claim 1, wherein said apparatus is further configured in use for releasably affixing thereto said one or more items with said one hand or with another hand of the user, at least when each said item is in said stowed position, and wherein said ring member is configured for remaining fixedly secured to the external surface at least during said affixing.

3. Apparatus according to claim 1, wherein said apparatus is further configured for selectively and alternately opening and closing the open end of said handlebar, at least when said ring member is fixedly secured to the external surface.

4. Apparatus according to claim 3, wherein said ring member comprises an end cap member configured for being selectively closing and opening said ring member, wherein in use and said end cap member is in a closed position with respect to the ring member the open end of said handlebar is closed and access is denied to the handlebar cavity, and wherein in use and said end cap member is in an open position with respect to the ring member the open end of said handlebar is open and access is permitted to the handlebar cavity.

5. Apparatus according to claim 4, wherein said apparatus is configured for releasably affixing thereto said one or more items by releasably clamping an engagement portion of each respective said one or more items between said end cap member and said ring member when said end cap member is engaged to the ring member and when the respective said one or more items are in said stowed position.

6. Apparatus according to claim 5, wherein each respective said item comprises a finger grip portion, said engagement portion, and a housing defining an internal storage volume, in serial relationship.

7. Apparatus according to claim 6, wherein said apparatus is configured for releasably clamping said engagement portion of each respective said one or more items between said end cap member and said ring member while concurrently compelling the respective said finger grip portion to be in facing relationship with an external portion of said apparatus.

8. Apparatus according to claim 5, wherein said apparatus comprises a clamping arrangement comprising at least one clamp configured for enabling the respective said engagement portion to be automatically clamped to said apparatus when the end cap member is closed, and said engagement portion to be automatically unclamped from said apparatus when said end cap member is open thereby enabling the respective said item to be retrieved from said handlebar cavity by gripping the respective said gripping portion and pulling the respective item out of said handlebar cavity via the respective said gripping portion.

9. Apparatus according to claim 8, wherein said at least one clamp comprises a respective first clamping member in the form of a clamping tab that projects distally from a respective side of said end cap member, and a respective second clamping member in the form of a clamping pad provided on a respective side of said ring member.

10. Apparatus according to claim 9, wherein a narrow opening is provided between clamping tab and said clamping pad when said end cap member is in the closed position, and wherein said narrow opening is configured for clamping therein said engagement portion of the respective said item while said engagement portion is folded over said clamping pad when said end cap member is in the closed position.

11. Apparatus according to claim 1, wherein said ring member comprises a generally tubular casing having a first open casing end and a second open casing end, and a longitudinal passageway extending between said first open casing end and said second open casing end.

12. Apparatus according to claim 1, wherein said ring member is configured for being sealingly engaged to the external surface of the open end when said apparatus is fixedly secured to the handlebar.

13. Apparatus according to claim 1, wherein said ring member comprises at least one longitudinal stop configured for abutting against the edge of the open end of the handlebar when the apparatus is fixedly secured to the handlebar.

14. Apparatus according to claim 1, wherein said apparatus is made from a weatherproof material.

15. Apparatus according to claim 1, further comprising at least one said item is in said stowed position accommodated within said handlebar cavity, each respective said item being in the form of a storage unit comprising a finger grip portion, an engagement portion, and a housing defining an internal storage volume, in serial relationship, wherein said engagement portion is configured to be releasably engaged to said apparatus while concurrently compelling the respective said finger grip portion to be in overlying relationship with an external portion of said apparatus.

16. Apparatus according to claim 15, wherein said finger grip portion is contiguous with said engagement portion and are in the form of any one of: a strip or material, a chord, a string, a chain.

17. Apparatus according to claim 15, wherein said storage unit is configured having an absence of engagement arrangement for fixedly engaging the storage unit to the inside surface of the internal cavity.

18. A bicycle handlebar comprising an apparatus as defined in claim 1.

19. A bicycle handlebar according to claim 18, wherein said bicycle handlebar is a drop handlebar.

20. A bicycle comprising a bicycle handlebar as defined claim 18.

21. A storage unit configured for being selectively stowed in and retrieved from an internal cavity of a bicycle handlebar via an apparatus, the bicycle handlebar having an internal handlebar cavity in open communication with an open end of the handlebar, said open end having an edge and an external surface, said apparatus being configured for being fixedly secured to the handlebar and comprising a ring member configured for being fixedly secured to the external surface of the open end of the handlebar and for selectively enabling access to the handlebar cavity via said ring member, wherein said apparatus is configured in use for at least enabling selective retrieval from the handlebar cavity of said storage unit with one hand of a user at least while the bicycle is in motion, said storage unit being in a stowed position accommodated within said handlebar cavity and wherein said ring member is configured for remaining fixedly secured to the external surface at least during said retrieval.

22. The storage unit according to claim 21, comprising a housing having a proximal end and a distal end and further defining an internal storage volume, wherein said distal end comprises a finger grip portion, and wherein said storage unit is configured having an absence of engagement arrangement for fixedly engaging the storage unit to the inside surface of the internal cavity.

23. Apparatus for a bicycle handlebar, the bicycle handlebar having an internal handlebar cavity in open communication with an open end of the handlebar, said open end having an edge and an external surface, the apparatus being configured for being fixedly secured to the handlebar and for selectively enabling access to the handlebar cavity via said apparatus, wherein said apparatus is configured for use with at least one storage unit, said storage unit comprising a finger grip portion and a housing defining a storage volume, at least a part of said housing configured for being accommodated in a stowed position within said handlebar cavity, said storage unit further comprising an engagement portion intermediate said finger grip portion and said housing, and wherein said apparatus is configured for releasably clamping said engagement portion while said housing is in said stowed position and while concurrently compelling said finger grip portion to be in facing relationship with an external portion of said apparatus.
